(19) United States
(12) Patent Application Publication
(10) Pub. No.: US 2015/0222220 A1
(43) Pub. Date: Aug. 6, 2015

(54) AERODYNAMIC AND FOOTING DESIGN FOR SOLAR PANEL RACKING SYSTEMS

(71) Applicants: MIKA Brian LAITILA, Peterborough (CA); Antero Samuel LAITILA, Peterborough (CA); Toni Peter LAITILA, Peterborough (CA)

(72) Inventors: Mika Brian Laitila, Peterborough (CA); Antero Samuel Laitila, Peterborough (CA); Toni Peter Laitila, Peterborough (CA)

(21) Appl. No.: 14/420,589

(22) PCT Filed: Aug. 12, 2013
(86) PCT No.: PCT/CA2013/000706

§ 371 Date: Feb. 9, 2015

Related U.S. Application Data
(60) Provisional application No. 61/681,943, filed on Aug. 10, 2012.

(51) Int. Cl. H02S 20/23; B32B 5/18; B32B 3/26

(52) U.S. Cl. CPC H02S 20/23; B32B 3/263; B32B 5/18; B32B 2250/02; B32B 2266/0228; B32B 2305/022

(57) ABSTRACT

A footing for distributing loads over a mounting surface from a ballasted mounting system supporting a solar panel, the footing comprising a body composed of a closed-cell plastics based foam material capable of experiencing body deformation in the presence of rigid objects pressed against the body and one or more further features of: at least one slot located in an exterior face allowing the flow of water between a first side and a second side of the body and/or a cladding layer affixed to a first exterior face of the body to provide a stacked layer arrangement for the body with the affixed cladding layer, such that a thickness of the cladding layer is less than a thickness of the body and a coefficient of friction for material of the cladding layer is greater than a coefficient of friction for the closed-cell plastics based foam material, the thickness of the cladding layer providing for said body deformation when the rigid foreign object is pressed against the cladding layer.

### CROSS REFERENCE TO RELATED APPLICATIONS

This application is a continuation-in-part of pending PCT International Application No. PCT/CA2013/000462 filed May 14, 2013 which claims the benefit of U.S. patent application Ser. No. 13/470,808 filed May 14, 2012; and U.S. Provisional Application No. 61/681,943 filed Aug. 10, 2012, the contents of which are incorporated herein by reference.

### FIELD

The present invention relates to solar panel racking systems.

### BACKGROUND

Solar racking systems are designed to be capable of bearing the weight of the solar panels and maintain the structural integrity of the racking system in the presence of loading, due to environmental considerations such as snow and/or ice accumulation and wind loading. It is important that solar panels are properly installed in order to maximize panel operational lifespan and operational efficiency. Large flat top roofs are a preferred mounting location for racking systems, however these locations are also subject to stringent excess weight distribution rules due to existing structural limitations of the buildings (typically designed without solar panel installation in mind). Footings are typically employed as mounting structures for solar racking as a weight distribution mechanism. However, current installation practices for footings include the use of polystyrene, which has a lower than desired coefficient of friction that can result in more ballast weight required for the solar racking installation.

Alternative footing designs can also employ rubber material to provide an increased friction coefficient, however rubber material is more expensive than polystyrene and is also denser than polystyrene and therefore relatively less absorbent (i.e. deformable) to accommodate impact due to rocks and other impact hazards in the roof environment. For example, it is desirable for the footing material to be able to absorb through material deformation any rocks or other irregular objects that may lie in between the roof membrane and the footings, thus helping to avoid denting of the roof membrane and risking potential damage to the membrane integrity. Further, since rubber footings are typically thinner than polystyrene footings, the ability of rubber footings to provide for adequate weight distribution of the solar racking over the roof surface can be an issue.

Another consequence of using rooftops as mounting locations is that the rooftops are relatively exposed and therefore subject to increased wind and precipitation exposure, which generates dynamic wind uplift forces on the racking systems. Other design considerations are static snow loading in northern climates. Therefore, there is a need for proper design of the racking systems to account for these additional dynamic and static forces.

In terms of precipitation exposure, footings should be designed so as to provide for adequate water drainage in and around installed solar racking, so as to avoid water pooling which can cause damage to the roof membrane and create leakage issues over time. Current footing installation practices include custom installation of polystyrene footings on site involving cutting up of larger polystyrene sheets into a series of smaller sized footings to allow for water drainage. This practice of custom installation undesirably increases the complexity and cost of the installation. Further, the presence of drainage spacing between the series of smaller sized footings has a disadvantage of having less surface area contact between the footings and the solar rack (due to the absence of the footings in the spaces), as compared to a more continuous and distributed central footing surface. This produces the undesirable consequence of increased loading concentration (e.g. the creation of a more point loaded system due to the series of discontinuities in the footings introduced because of the drainage spacing) on the roof membrane and underlying roof support structure.

Also, it is an issue to provide for adequate connection between the base of the solar racking and the footings, such that the solar racking does not shift with respect to the footing over time (e.g. due to horizontal forces due to wind loading).

In terms of increased wind exposure, one way to account for the wind uplift forces is to provide for ballast weights in order to resist any wind generated uplift forces, however the disadvantage with using ballast weights is increased excess weighting applied to the roof structure. Accordingly, there is a need to provide for proper aerodynamic design of the racking systems, in order to reduce the effect of the any generated uplift forces and therefore reduce the size and weight of ballast. This is important, as the alternative to ballasted racking systems are systems that are lagged to the roof surface. These lagged racking systems may not need ballast weights, however they offer the undesirable feature of penetrating the roof membrane which can cause potential leakage and voiding of roof warranties.

Further, there is increased awareness in the solar racking design community of manufacturing, installation labour and material costs associated with the solar racking and associated footings as well. Therefore, minimizing the amount of material used in racking system and associated footings manufacture, as well as minimizing costly material components of the racking system and associated footings is desired.

Another wind effect issue related to solar racking design is for uplift forces that can be generated, due to the flow of air over and around the racking systems. In particular for solar arrays, uplift and drag forces (due to wind effects) can be an issue as there is a pressure differential inside and outside of the rack. This problem can be an issue particularly with an enclosed racking design (e.g. racking designs having coverings around the sides and underside of the solar panel that enclose an interior space) verses other open type rack systems that do not have full base coverings and/or other side coverings. It is understood that enclosed racking designs can have benefits, such as keeping out debris/pests, minimized point loads, larger footing surface areas to help maximize frictional contact with roof surface, etc. However, a consequence of the enclosed design is increases in magnitude of uplift forces generated by wind exposure of the solar racking system, which can be substantial in exposed areas such as rooftops of taller buildings.

### SUMMARY

It is an object of the present invention to provide a solar racking footing and ballasted mounting system that obviate or mitigates at least one of the above-presented disadvantages.

Wind effect issues related to solar racking design is for uplift forces that can be generated, due to the flow of air over and around the racking systems. In particular for solar arrays, uplift and drag forces (due to wind effects) can be an issue as there is a pressure differential inside and outside of the rack. This problem can be an issue particularly with an enclosed racking design (e.g. racking designs having coverings around the sides and underside of the solar panel that enclose an interior space) verses other open type rack systems that do not have full base coverings and/or other side coverings. It is understood that enclosed racking designs can have benefits, such as keeping out debris/pests, minimized point loads, larger footing surface areas to help maximize frictional contact with roof surface, etc. However, a consequence of the enclosed design is increases in magnitude of uplift forces generated by wind exposure of the solar racking system, which can be substantial in exposed areas such as rooftops of taller buildings. Alternatively, in terms of precipitation exposure, footings can be designed so as to provide for adequate water drainage in and around installed solar racking, so as to avoid water pooling which can cause damage to the roof membrane and create leakage issues over time. Further, or in addition to, current installation practices for footings can include the use of polystyrene, which has a lower than desired coefficient of friction that can result in more ballast weight required for the solar racking installation. Contrary to the present prior art systems there is provided a mounting system for positioning a solar panel on a mounting surface, the system comprising: a cover assembly for coupling to the solar panel for retaining the solar panel over the mounting surface at an inclined angle to the mounting surface, the cover assembly having a proximal end for positioning adjacent to the mounting surface and a distal end for coupling to the solar panel, the cover assembly when coupled to the solar panel cooperating to define an interior enclosed volume between the cover assembly and the solar panel; a first cover panel of the cover assembly comprising first sheet material positioned at the proximal end, the first cover panel having a first aperture area located on a portion of first cover panel, the first aperture area having one or more first apertures extending through a thickness of the first sheet material providing for communication of air between the interior closed volume and an ambient exterior of the cover assembly; a second cover panel of the cover assembly comprising second sheet material positioned between the proximal end and the distal end, the second cover panel having a second aperture area located on a portion of second cover panel, the second aperture area having one or more second apertures extending through a thickness of the second sheet material providing for communication of air between the interior closed volume and the ambient exterior of the cover assembly.

Another aspect provided is a cover assembly for coupling to a solar panel for retaining the solar panel over a mounting surface at an inclined angle to the mounting surface, the cover assembly having a proximal end for positioning adjacent to the mounting surface and a distal end for coupling to the solar panel, the cover assembly when coupled to the solar panel cooperating to define an interior enclosed volume between the cover assembly and the solar panel, the cover assembly including: a first cover panel of the cover assembly comprising first sheet material positioned at the proximal end, the first cover panel having a first aperture area located on a portion of first cover panel, the first aperture area having one or more first apertures extending through a thickness of the first sheet material providing for communication of air between the interior closed volume and an ambient exterior of the cover assembly; and a second cover panel of the cover assembly comprising second sheet material positioned between the proximal end and the distal end, the second cover panel having a second aperture area located on a portion of second cover panel, the second aperture area having one or more second apertures extending through a thickness of the second sheet material providing for communication of air between the interior closed volume and the ambient exterior of the cover assembly.

Another aspect provided is a footing for distributing loads over a mounting surface from a ballasted mounting system supporting a solar panel, the footing comprising a body composed of a closed-cell plastics based foam material capable of experiencing body deformation in the presence of rigid objects pressed against the body and one or more further features of: at least one slot located in an exterior face and extending from a first side to a second side opposite the first side and positioned away from a third side and a fourth side, such that the first side and the second side and the third side and the fourth side define edges of the first exterior face, the at least one slot for allowing the flow of water between the first side and the second side when the first exterior face is positioned adjacent to the mounting surface; and a second exterior face of the body, the second exterior face opposite the first exterior face and configured for connecting to a bottom panel of the ballasted mounting system; and/or a cladding layer affixed to a first exterior face of the body to provide a stacked layer arrangement for the body with the affixed cladding layer, such that a thickness of the cladding layer is less than a thickness of the body and a coefficient of friction for material of the cladding layer is greater than a coefficient of friction for the closed-cell plastics based foam material, the thickness of the cladding layer providing for said body deformation when the rigid foreign object is pressed against the cladding layer.

An aspect provided is a footing for distributing loads over a mounting surface from a ballasted mounting system supporting a solar panel, the footing comprising: a body composed of a closed-cell plastics based foam material capable of experiencing body deformation in the presence of rigid objects pressed against the body having: a first exterior face of the body with at least one slot located in the exterior face and extending from a first side to a second side opposite the first side and positioned away from a third side and a fourth side, such that the first side and the second side and the third side and the fourth side define edges of the first exterior face, the at least one slot for allowing the flow of water between the first side and the second side when the first exterior face is positioned adjacent to the mounting surface; and a second exterior face of the body, the second exterior face opposite the first exterior face and configured for connecting to a bottom panel of the ballasted mounting system.

A further aspect provided is a footing for distributing loads over a mounting surface from a ballasted mounting system supporting a solar panel, the footing comprising: a body composed of a closed-cell plastics based foam material capable of experiencing body deformation in the presence of rigid objects pressed against the body and a cladding layer affixed to a first exterior face of the body to provide a stacked layer arrangement for the body with the affixed cladding layer, such that a thickness of the cladding layer is less than a thickness of the body and a coefficient of friction for material of the cladding layer is greater than a coefficient of friction for the closed-cell plastics based foam material, the thickness of the cladding layer providing for said body deformation when the rigid foreign object is pressed against the cladding layer.

### BRIEF DESCRIPTION OF THE DRAWINGS

Exemplary embodiments of the invention will now be described in conjunction with the following drawings, by way of example only, in which:

FIG. 1 is a front perspective view of a ballasted mounting system without solar panel;

FIG. 2 is a rear perspective view of FIG. 1 of the ballasted mounting system with solar panel;

FIG. 3 is a planar side view of a cover assembly of the ballasted mounting system of FIG. 1;

FIG. 4 is an alterative embodiment of the ballasted mounting system of FIG. 1;

FIG. 5 is a perspective view of a support member of the support structure of the ballasted mounting system of FIG. 1;

FIG. 6 is an alternative embodiment of the support member of FIG. 5;

FIG. 7 is a perspective view of the cover assembly of FIG. 1 including footings;

FIG. 8 is a side view of an alternative embodiment of the ballasted mounting system of FIG. 1;

FIG. 9 is a side view of a further alternative embodiment of the ballasted mounting system of FIG. 1;

FIG. 10 shows a perspective view of a solar array having multiple ballasted mounting systems of FIG. 1;

FIG. 11 is a side view of the ballasted mounting system of FIG. 1 with solar panel;

FIG. 12 is a front view of the ballasted mounting system of FIG. 1 with solar panel;

FIG. 13 is an alternative embodiment of the ballasted mounting system of FIG. 12 with solar panel;

FIG. 14 shows a rear perspective view of the ballasted mounting system of FIG. 1 with air gap;

FIG. 15 shows an exploded perspective view of assembly of the ballasted mounting system of FIG. 1;

FIG. 16 is a further exploded perspective view of assembly of the ballasted mounting system of FIG. 1;

FIG. 17 is a cross-sectional view of an assembled cover assembly and support structure for adjacent ballasted mounting systems of FIG. 1;

FIG. 18 shows a perspective exploded front view of connection between the cover assembly and the support structure of the ballasted mounting system of FIG. 1;

FIG. 19 shows an alternative embodiment of a footing design of the ballasted mounting system of FIG. 7;

FIG. 20 is a perspective view of the footing of FIG. 19;

FIG. 21a is an alternative embodiment of the footing of FIG. 20;

FIG. 21b is a further alternative embodiment of the footing of FIG. 20;

FIG. 22a is an assembled footing of the footing of FIG. 21a;

FIG. 22b is an assembled footing of the footing of FIG. 21b;

FIG. 23 shows a side view of an installed footing of the footings of FIGS. 21a and 21b; and

FIG. 24 is an exploded view of the footing of FIG. 21a in relation to the ballasted mounting system of FIG. 19;

FIG. 25 is a further embodiment of the cover panel of FIG. 3;

FIG. 26 is a bottom view of the system of FIG. 26;

FIG. 26 is a still further embodiment of the cover panel of FIG. 3; and

FIGS. 27-37 are alternative embodiments of the cover panel of FIG. 1.

### DESCRIPTION OF PREFERRED EMBODIMENTS

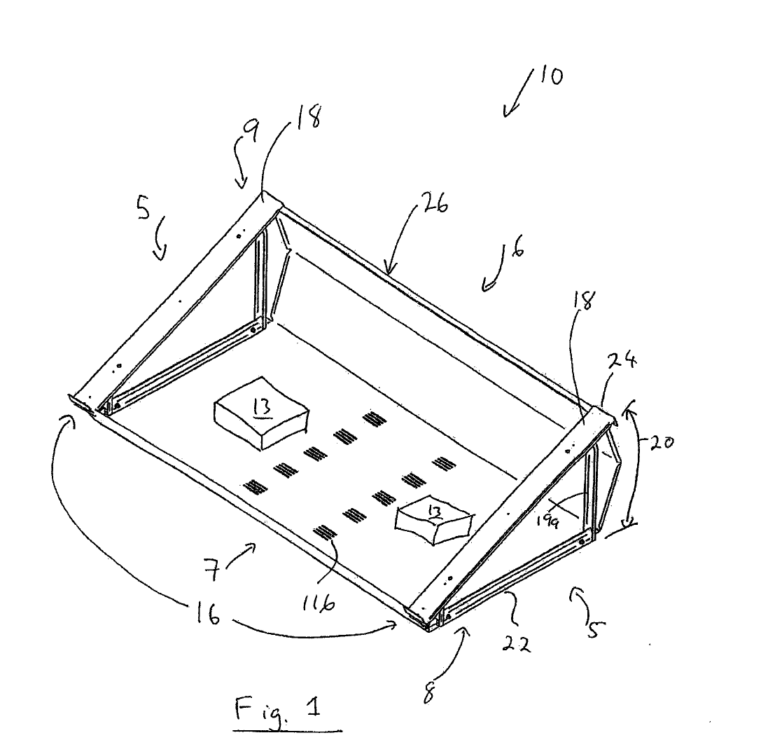

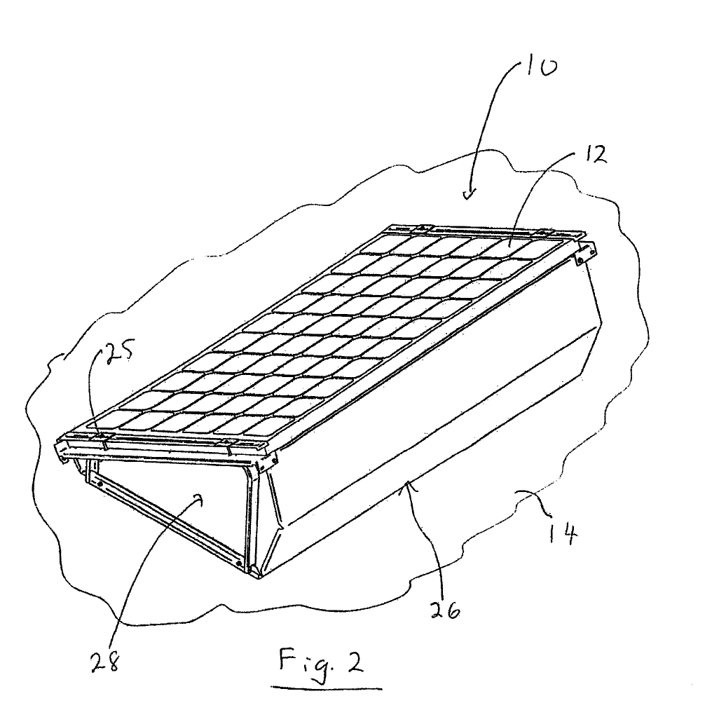

Referring to FIG. 1, shown is an example ballasted mounting system 10 for supporting a solar panel 12 (e.g. photovoltaic collector, solar thermal collector, etc.) over a mounting surface 14 (see FIG. 2). The system 10 can have a support structure 16 with a number of individual support members 18 for attaching to and retaining the solar panel 12 over the mounting surface 14, preferably at an inclined angle 20 to the mounting surface 14. The support structure 16 has a proximal end 22 positioned adjacent to the mounting surface 14 and a distal end 24 attachable (for example using mechanical fasteners 25 such as bolts or screws) to the solar panel 12. The system 10 has a rear side 6, a front side 7, a bottom side 8 and a top side 9, such that the bottom side 8 is positioned adjacent to the mounting surface 14 and the top side 9 is configured to receive and hold the solar panel 12. The system 10 can also have end sides 5 and accommodate the placement of ballast weights 13 in an interior 28 (see FIG. 2).

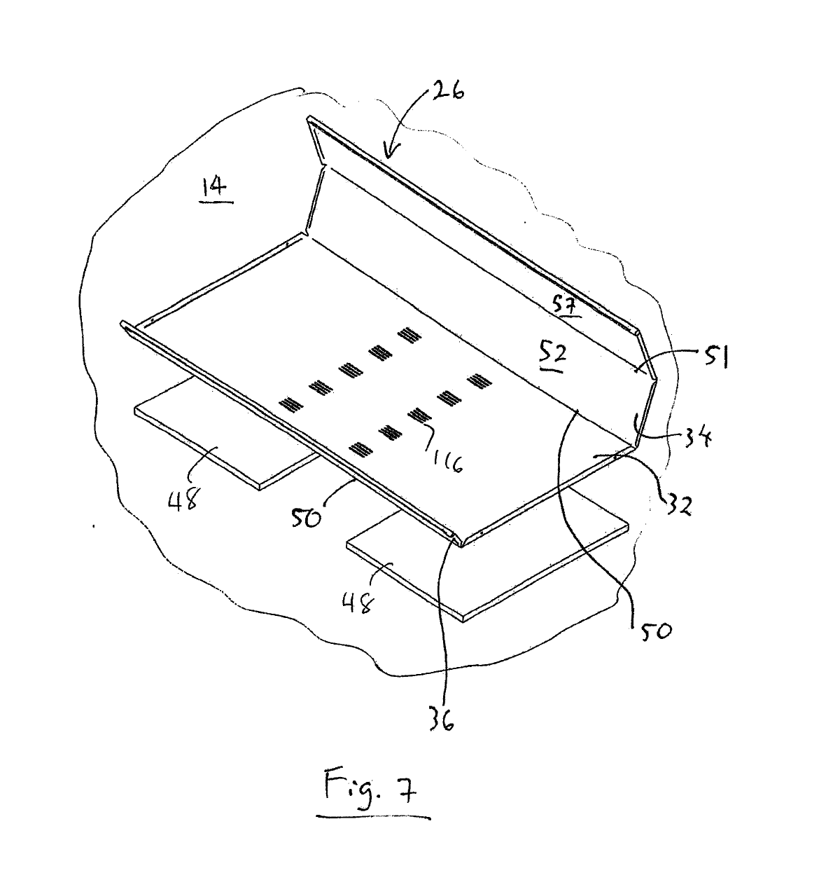

The mounting system can include the support structure 16 coupled to a cover assembly 26 that has a first (e.g. bottom) cover panel 32 (see FIG. 2) positioned between the support structure 16 and the mounting surface 14, such that the first cover panel 32 provides for weight distribution of the system 10 via one or more footings 48 (see FIG. 7) allowing for distribution of the loads (of the support structure 16, solar panel 12, snow loading and/or wind loading) of the mounting system 10 preferably uniformly across a maximized surface area of the mounting surface 14. It is also recognised that the footings 48 can be used to assist in distribution of the loading onto the mounting surface 14, including absorption through deformation of any surface irregularities due to foreign objects (e.g. rocks, branches, loose fasteners, etc.) and/or irregularities in the mounting surface 14 itself (e.g. cladding thickness variability). It is also recognised that the larger surface area of the bottom cover panel 32 provides for a greater surface area of the footings 48 (i.e. fewer larger sized footings 48 as compared to multiple smaller sized footings) to be used, which is advantageous as it can provide for greater friction forces (e.g. through a larger coefficient of friction and/or surface area) between the mounting system 10 and the mounting surface 14. It is recognised that greater friction forces are beneficial to the mounting system 10 since they help in resisting undesirable displacement of the mounting system 10 across the mounting surface 14 due to exerted wind forces.

Further, the use of large footings 48 provides for a more continuous and distributed central footing surface, as further described below, as compared to prior art systems in which the presence of discontinuous drainage spacing between the series of smaller sized footings has the disadvantage of decreasing surface area contact between the footings and the solar rack (due to the absence of the footings in the spaces). It is recognised that too much drainage spacing between footings 48 produces the undesirable consequence of increased loading concentration (e.g. the creation of a more point loaded system due to the series of discontinuities in the footings introduced because of the drainage spacing) on the membrane of the mounting surface 14 and underlying roof support structure (not shown). As further described below, provided is a footing 48 having a continuous mounting surface while at the same time providing for water drainage through the footing 48.

The optional support members 18 of the support structure 16 can be designed to be capable of bearing the weight of the solar panel 12, so as to inhibit the mounting system 10 from collapsing (i.e. experience failure in the structural integrity of the mounting system 10). It is recognized that the support members 18 can also be designed to maintain the structural integrity of the system 10 in the presence of loading, due to environmental considerations, such as snow and/or ice accumulation and wind loading. It is recognized that the mounting surface 14 can be a suitable surface such as but not limited to a relatively level rooftop of a building, a mildly sloped rooftop, and a relatively flat ground surface. Preferably, the mounting surface 14 is level and/or mildly sloped (sloping can be up to 5 degrees from horizontal depending upon the coefficient of friction between the cladding of the mounting surface 14 and the mounting system 10).

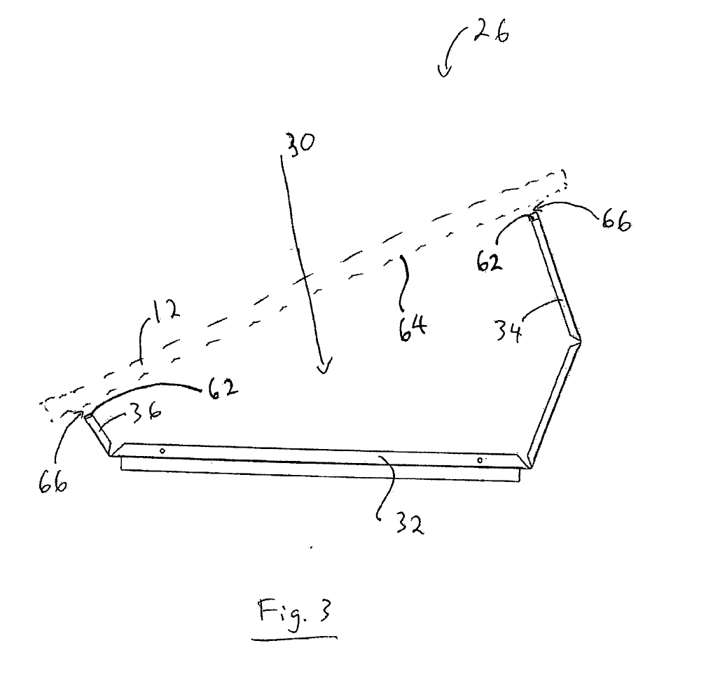

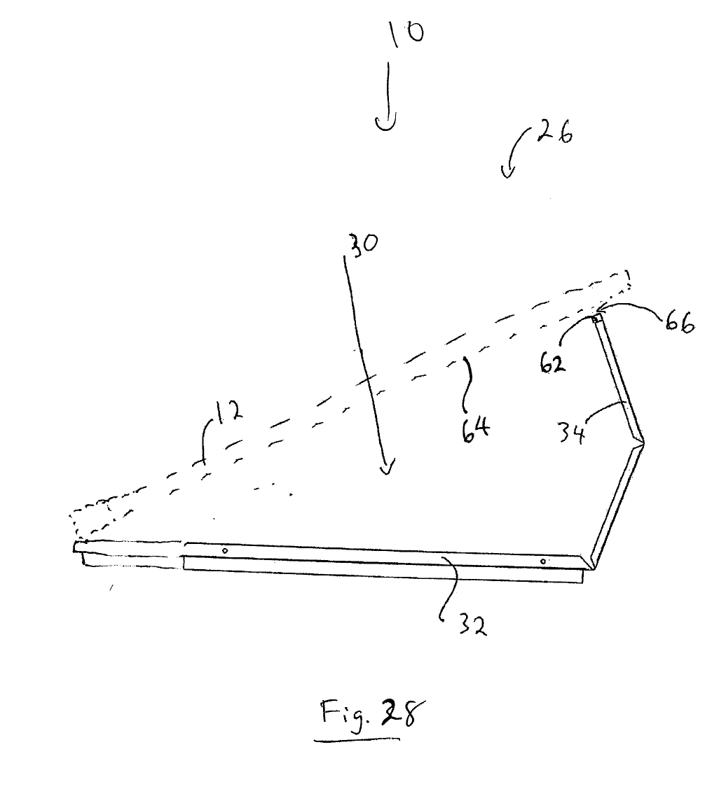

Referring again to FIG. 3, the system 10 as another alternative embodiment can have or be otherwise comprised of the cover assembly 26 manufactured out of sheet material that is coupled to the solar panel 12, thereby cooperating with the solar panel 12 to define the interior 28 of the system 10. The cover assembly 26 of the system 10 can be designed to be capable of bearing the weight of the solar panel 12, so as to inhibit the mounting system 10 from collapsing (i.e. experience failure in the structural integrity of the mounting system 10). As such, the mounting system 10 may not need any support members 18 and thus be able to rely upon none or a limited number of support members 18 to support and retain the solar panel 12 over the mounting surface 14. As shown in FIG. 28, the cover assembly 26 can include only the first cover panel 32 and a second cover panel 34, as compared to FIG. 3 which can include an optional third cover panel 36.

Referring again to FIGS. 1, 2 and 3, as another alternative embodiment, the system 10 has the cover assembly 26 manufactured out of sheet material that is fastened (for example using mechanical fasteners 25 such as bolts, rivets, pop rivets, and/or screws) to the support structure 16, thereby cooperating with the solar panel 12 to define the interior 28 of the system 10. The cover assembly 26 is a separate component of the mounting system 10 from the support structure 16 component. The cover assembly 26 is fastened to the support structure 16 by a plurality of fasteners (e.g. mechanical), such that the cover assembly 26 is detachable from the support structure 16 once installed. In other words, the cover assembly 26 can be removed from the support structure 16 by unfastening the plurality fasteners used to originally attach the cover assembly 26 to the support structure 16 during installation of the mounting system 10 on the mounting surface 14. The cover assembly 26 is separate from the support structure 16 and attachable and detachable to the support structure 16 via the plurality of fasteners.

It is also recognized that an alternative embodiment to the system 10 is where the cover assembly 26 is not separate from the support structure 16 and is therefore fixedly attached to the support structure 16. A further alternative embodiment of the system 10 is where the cover assembly 26 is configured to be capable of bearing the weight of the solar panel 12, so as to inhibit the mounting system 10 from collapsing (i.e. experience failure in the structural integrity of the mounting system 10). It is recognized that the plurality of panels 30 can be designed to maintain the structural integrity of the system 10 in the presence of loading, due to environmental considerations, such as snow and/or ice accumulation and wind loading. As discussed above, the mounting system 10 can be comprised of only the cover assembly 26 for coupling directly to the solar panel 12, such that the cover assembly 26 is configured as a weight bearing structure for the weight of the solar panel 12. In this configuration, the cover assembly 26 would not use one or more of the support members 18 of the support structure 16 (see FIGS. 3, 28). Also considered is where the optional support members 18 are incorporated as load bearing members integrated into the structural material of the cover panels 30, as desired.

Referring again to FIGS. 1, 2 and 3, the cover assembly 26 can have a number of different panels 30 that can be used to inhibit exposure of the interior 28 from undesirable environmental elements such as but not limited to the collection of precipitation (e.g. rain or snow) in the interior 28. Further, the shape and/or orientation and/or venting configuration of the panels 30 can be designed to decrease the degree of wind loading (e.g. exerted wind uplift forces) experienced by the system 10 according to aerodynamic principles. The cover assembly 26 has a first cover panel 32 positioned between the support structure 16 and the mounting surface 12 and a second cover panel 34 positioned between the proximal end 22 and the distal end 24 of the support structure 16 at the rear side 6, such that the cover assembly 26 cooperates with the solar panel 14 to form the interior 28. The cover assembly 26 can also have an optional third cover panel 36 positioned between the proximal end 22 and the distal end 24 of the support structure 16 at the front side 6. It is recognized that the sheet material of the cover assembly 26 can be any durable material that is resistive to excessive damage from environmental factors such as but not limited to sunlight exposure, moisture, and/or wind and wind driven projectiles. Example sheet materials for the cover assembly 26 can be materials such as but not limited to plated steel, aluminum, and/or UV resistant plastics. It is recognised that any of the cover panels 30 can be optional in terms of the cover assembly 26. For example, the second cover panel 34 and/or the third cover panel 36 can be optional elements of the cover assembly 26. In other words, the cover assembly 26 can be embodied as just the first cover panel 32 (e.g. an open front and open rear cover assembly 26), just the first cover panel 32 and the second cover panel 34 (e.g. an open front and closed rear cover assembly 26), just the first cover panel 32 and the third cover panel 36 (e.g. an open rear and closed front cover assembly 26), just the first cover panel 32 and the second cover panel 34 and the third cover panel 36 (e.g. a closed front and a closed rear cover assembly 26), or any combination thereof. It is also recognised that according to the design of the cover assembly 26, the first cover panel 32 and the second cover panel 34 and the third cover panel 36 are integrally formed with one another as part of the sheet material. Alternatively, according to the design of the cover assembly 26, the first cover panel 32 and the second cover panel 34 are integrally formed with one another as part of the sheet material (e.g. resulting in either an open front cover assembly 26 or a closed front cover assembly 26 such that the third cover panel 36 is separate sheet material fastened—e.g. using mechanical fasteners—to the sheet material forming the first cover panel 32 and the second cover panel 34). Alternatively, according to the design of the cover assembly 26, the first cover panel 32 and the third cover panel 36 are integrally formed with one another as part of the sheet material (e.g. resulting in either an open rear cover assembly 26 or a closed front cover assembly 26 such that the second cover panel 34 is separate sheet material fastened—e.g. using mechanical fasteners—to the sheet material forming the first cover panel 32 and the third cover panel 36).

Another related consideration is that the same cover assembly 26 can be used for both northern and southern climates that encounter similar wind loading, while the optional support structure 16 for the northern climate installation would be rated for higher static loading due to snow load considerations as compared to the support structure 16 for the southern climate installation that would not have to account for snow loading. Thus in this example, the southern climate installation of the mounting system 10 could be lighter in system weight (as compared to the northern climate installation) as the support structure 16 for the southern climate mounting system 10 could be made out of thinner (or lower number of) materials, thus providing for cost savings due to less material usage in the construction of support structure 16.

In terms of having separate and detachable support structure 16 and associated cover structure 26, as one of the system 10 embodiments, another reason for having separate cover assembly 26 and support structure 16 components of the mounting system 10 is that in southern climates, similar support structures 16 can be used with alternative cover assemblies 26, the difference between the different cover assemblies 26 being that a lesser number of cover panels 30 can be employed in southern climates. For example, the cover assembly 26 in southern climates can have the front cover panel 36 missing or otherwise omitted from the cover assembly 26, due to lower angles of inclination of the solar panel 12 (i.e. from the mounting surface 14) providing for a reduced need for wind deflection. For further example, the cover assembly 26 in southern climates can have the rear cover panel 34 missing or otherwise omitted from the cover assembly 26, due to lower angles of inclination of the solar panel 12 (i.e. from the mounting surface 14) providing for a reduced need for wind deflection. For further example, the cover assembly 26 in southern climates can have both the front cover panel 36 and rear cover panel 34 missing or otherwise omitted from the cover assembly 26, due to lower angles of inclination of the solar panel 12 (i.e. from the mounting surface 14) providing for a reduced need for wind deflection. It is also recognised that for cover assemblies 26 designed as load bearing structures (e.g. with or without a cooperating or integrated support structure 16 for supporting the solar panel 12 and associated environmental loading), alternative cover assembly 26 designs can also be provided as desired. For example, a load bearing cover assembly 26 can be formed from a single piece of material such as a single piece of sheet material.

It is important that solar panels 12 are properly installed in order to maximize panel operational lifespan and operational efficiency. Large flat top roofs are a preferred mounting surface 16 for solar panels 12, however these locations are also subject to stringent excess weight (of the solar panels 12) distribution rules due to existing structural limitations of the buildings (typically designed without solar panel installation in mind). Another consequence of using rooftops as mounting surfaces 16 is that the rooftops are relatively exposed and therefore subject to increased wind exposure (e.g. generating dynamic wind uplift forces on the systems 10) as well as static snow load considerations in northern climates, thus increasing the need for proper design of the systems 10 to account for these additional dynamic and static forces exerted on the systems 10. One way to account for the wind uplift forces is to provide for ballast weights 13 (see FIG. 1) in order to resist any wind generated uplift forces, however the disadvantage with using ballast weights 13 is increased excess weighting applied to the roof structure. Accordingly, the need to provide for proper aerodynamic design of the systems 10, including venting positioned in portions of selected cover panels 30 (e.g. in both the first cover panel 32 and second cover panel 34) in order to reduce the effect of the any generated uplift forces, is desired using an optimally shaped and sized cover assembly 26. For example, the inclusion of vents 116 (see FIG. 1 for example) positioned on bottom cover panel 32 and an aperture area 66 (see FIG. 3) of the second cover panel 34 can cooperate to provide for air exchange from the interior 28 of the racking system 10 (when assembled) and the exterior environment, thus providing for a low pressure zone (i.e. lower in pressure than the pressure of the ambient environment adjacent to the cover panel 32) to be formed between the cover panel 32 and the mounting surface 14 in the vicinity of the venting 116. This low pressure zone can be beneficial in those instances where air flow is experienced over the racking system 10, i.e. directed away from the bottom cove panel 32 and over the solar panel 12, i.e. directed away from (i.e. inhibited) between bottom cover 32 and mounting surface 14 and/or (i.e. inhibited) between the solar panel 12 and proximal end of the cover assembly 26 and thus penetrating into the interior 28.

The inclusion of venting 116 on the exposed base cover 32 of rack system 10 between footings 48, for example, can thus be used to form this low pressure zone to promote attraction of the bottom cover 32 towards the mounting surface 14 by generating a downwards force on the bottom cover panel 32 directed towards the mounting surface 14. Therefore, providing of at least vents 116 on bottom cover 32 (for example in combination with aperture area 66) facilitates air to be entrained out of rack system interior 28, which can have the benefit of promoting generation of lower (than ambient pressure) air pressure inside (i.e. in interior 28) as compared to outside (i.e. in the immediate environmental exterior vicinity—such as between solar panel 12 and the exterior environment about racking system 10) of rack system 10, therefore helping to reduce uplift and/or drag forces exerted on racking system 10 due to wind loading effects.

Accordingly, it is recognized that the system 10 can have the components of the support structure 16 and a cover assembly 26 fastened (e.g. via a plurality of fasteners) to the support structure 16, such that the cover assembly 26 can be detachable from the support structure 16 once assembled. One advantage of having the system 10 with separate support structure 16 and cover assembly 26 components, which are assembled together using a number of different material elements (e.g. are not formed from a single piece of material such as a single piece of sheet material), is that each component can be optimized for its intended purpose, i.e. structural integrity provided by the support structure 16 in resisting environmental forces (e.g. static snow weight and dynamic wind load forces) and solar panel 12 forces (e.g. static panel weight) and wind deflection provided by the cover assembly 26 to decrease the degree of dynamic wind forces experienced by the support structure 16.

It is also recognised that in the case where the support structure 16 and cover assembly 26 are individual and separate components of the mounting system 10, such that the support structure 16 and cover assembly 26 are manufactured out of materials that are physically separate from one another, the support structure 16 and cover assembly 26 can be preferably assembled as well as disassembled from one another using the plurality of fasteners. Thus can be advantageous in this described configuration as separate (or separable) components that the support structure 16 and cover assembly 26 can be modified or changed individually on site during installation based on environmental site considerations. For example, a support structure 16 designed for a type of solar panel 12 can be fitted with a high wind configuration of cover assembly 26 (e.g. having both second 32 and third 34 cover panels attached to the first cover panel 32), as compared to using the same support structure 16 for the same type of solar panel 12 fitted with a different cover assembly 26 for lower wind environments (e.g. having only the second 32 cover panel attached to the first cover panel 32). In any of the configurations of the mounting system 10 described, it is recognised that formation of the enclosed interior 28 along with provision of venting 116 on the bottom cover panel 32 and aperture area 66 of the second cover panel 34 provides for preferential generation of the low pressure zone in the interior 28 and thus also in the vicinity of the venting 116 adjacent to the mounting surface 14.

In this manner, the separate support structure 16 and cover assembly components of the mounting system 10 can be optimized for their intended purpose as they, for example, can be attachable and detachable to one another using a plurality of fasteners. It is also recognised that since the cover assembly 26 and support structure 16 can be separate components fastened to one another, they can be made out of different materials, e.g. plated steel for the support structure 16 and aluminum for the cover assembly 26, a different gauge of material for the support structure 16 as compared to the gauge of material for the cover assembly 26 (e.g. thinner sheet material for the cover assembly 26 as compared to thicker structural tubing, thicker sheet material or thicker bar stock of the support structure 16, plastic of other polymer for the cover assembly 26 as compared to metal for the support structure 16, plastic of other polymer for the support structure 16 as compared to metal for the cover assembly 26, and/or any combination thereof.

In this manner the thickness and/or type (and therefore cost) of the sheet material of the cover assembly 26 can be minimized, as the sheet material may not need to be sized (e.g. material thickness) for maintaining the structural integrity for supporting the weight of the solar panel 12 of the system 10, rather only to provide for wind deflection. As compared to the support structure 16 or cover assembly 26 designed as a load bearing structure, these need to be configured out of material that is capable of supporting the weight of the solar panel 12 as well as environmental stresses and loads introduced to the mounting system 10 due to wind loading and/or snow loading considerations. In addition, the shape and position of the panels 30 can be optimized for wind deflection (e.g. without having to also design them for their structural stability), for example the panels 30 can be positioned at angles to the solar panel 12 and mounting surface 14 that are preferential for wind deflection but may not be preferential to load transfer of the solar panel 12 weight to the mounting surface 14 in the case where the cover assembly 26 is non-load bearing. For example, referring to FIG. 3, the cover panel 34 is in a bent configuration due to wind deflection design optimization considerations while support element 19a of the support member 18 (see FIG. 1) is a straight element positioned parallel to the direction of the panel weight (e.g. a load transfer path parallel to gravity) assuming a relatively level mounting surface 14. Further, the material used to manufacture the support structure 16 can be comprised of less environmentally durable material due its reduced environmental exposure (i.e. due to increased protection afforded by the cover assembly 26 as compared to uncovered). However, it is also recognised that cover panel 34 can also be of a non-bent or other shaped configuration other than shown. One example is a straight panel positioned parallel to the direction of the panel 12 weight (e.g. a load transfer path parallel to gravity) assuming a relatively level mounting surface 14. Another example is a straight panel positioned non-parallel to the direction of the panel 12 weight (e.g. a load transfer path parallel to gravity) assuming a relatively level mounting surface 14.

In these manners, the cost of the support structure 16 can be minimized, as optimum shape, orientation, and materials of the individual support elements 18 can be chosen without having to account for increased environmental exposure and wind deflection considerations. Further, it is recognized that for custom installations of the system 10 (e.g. degree of wind exposure, angle of wind exposure, weight of solar panels 12 and associated equipment, number of solar panels, slope angle of mounting surface 14, etc.) the separate (i.e. attachable and detachable) components of the support structure 16 and the cover assembly 26 can optimized individually or together for material type selection, shape and orientation design, and/or material thickness considerations, depending on whether their design purpose is structural integrity or wind deflection/environmental protection respectively.

Another consideration for having separate cover assembly 26 and support structure 16 components is for operational temperature considerations of the solar panels 12. It is recognized that use of thicker gauge sheet metal for known enclosed solar racking systems (for example U.S. Pat. No. 6,968,654 having a frame made out of sheet metal bending operations), in order to provide the required structural support to the wind, snow, and panel loading, can contribute to higher insulating R values of the known enclosed solar racking system. This can be detrimental to solar panel 12 operation, as tests show that solar panels 12 operate more efficiently at cooler temperatures. Therefore, manufacturing of solar racking systems using lower gauge sheet metal can result in decreased efficiency of panel operation and/or increased manufacturing costs due to the need to manufacture additional venting in the sheet metal.

### Support Structure 16

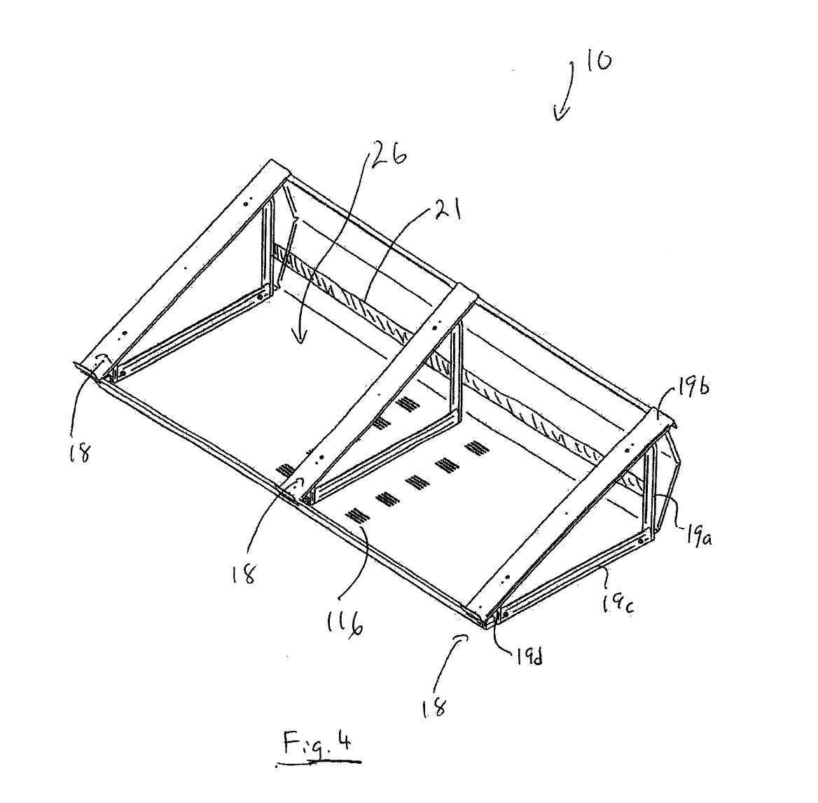

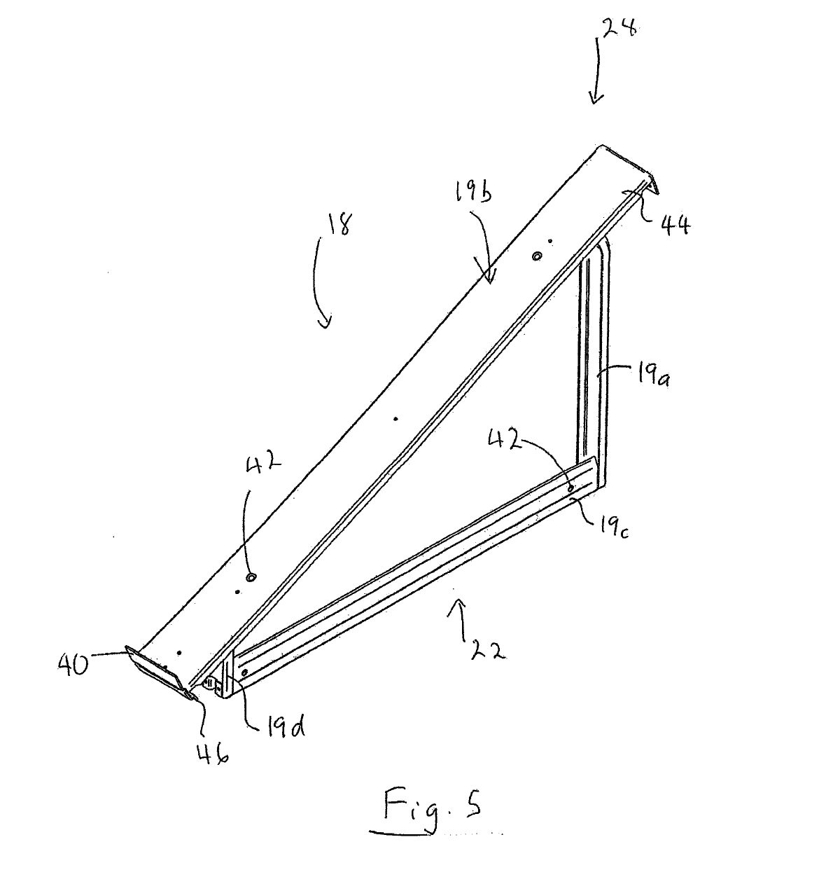

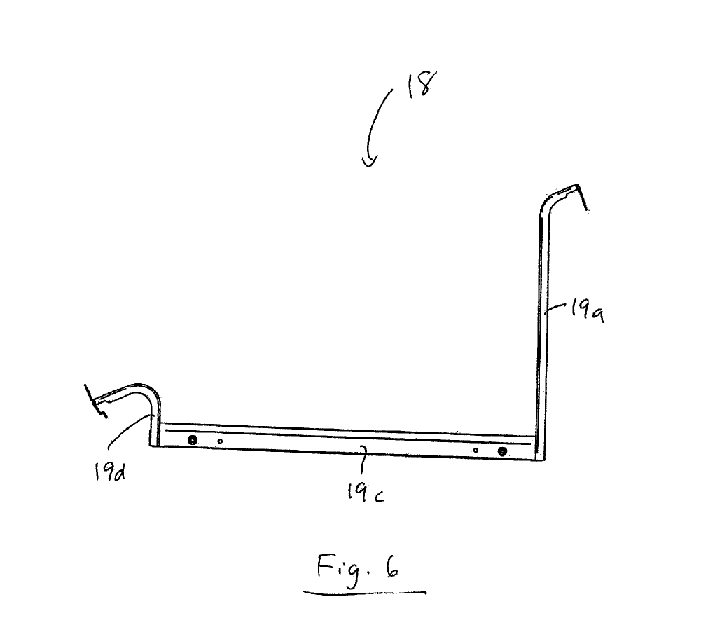

Referring to FIG. 4, it is envisioned that the optional support structure 16 can have a number of support members 18, connected to each other directly via optional intermediate support elements 21, indirectly connected to one another through attachment to the solar panel 12 to top elements 19b, indirectly through attachment to the cover assembly 26 with bottom elements 19c, and/or a combination thereof. It is also recognized that any portion of the support members 18 can be fastened to any portion of the cover assembly 26, such as show by example by the connection of bottom cover panel 32 with member element 19c and/or the connection of the rear cover panel 34 with member element 19b and/or the connection of the optional front cover panel 36 with member element 19d. Further, it is recognized that the connection between the support structure 16 and the cover assembly 26 can be done preferably through mechanical fasteners 25, however alternative methods of assembly can be employed including metallurgical fastening (e.g. welding) and/or chemical fastening (e.g. adhesives). The elements 19a,b,c,d, 21 are shown by example as elongate member elements. It is also recognized that the support structure 16 can have any number of support members 18 (e.g. two are shown in FIG. 1 and three are shown in FIG. 4 by example), so long as the overall support structure 16 is capable of maintaining the structural integrity of the system 10 due to solar panel 12 loading, wind loading and any other design considerations such as snow loading. Accordingly, the support member 18 can be configured as a triangular shaped support member shown in FIG. 5, as a U shaped support member as shown in FIG. 6, or as any other shaped member so long as the support member 16 is configured to retain and support the solar panel 12 in its inclined position on the mounting surface 14.

Referring to FIGS. 2 and 5, an example configuration of the support member 18 is shown having the top element 19b with support flange 40 for inhibiting the solar panel 12 from sliding off of the support member 18 and holes 42 for use with fasteners 25 that can be used to fasten the solar panel 12 to the support structure 16. The top element 19b also has a support surface 44 for receiving the underside of the solar panel 12 and can have an offset flange 46 for clipping or otherwise fastening to the cover panel 36 (see FIG. 3). Referring to FIG. 11, shown is an assembled system 10 such that connection between the offset flange 46 and the front cover panel 36 is accomplished by inserting a tab 47 of the offset flange 46 into a corresponding slot 49 (see FIG. 18) of the front cover panel 36 and then positioning the support member 18 for fastening to the cover assembly using corresponding holes and fasteners 25. The use of the offset flange 46 can reduce the need for extra fasteners 25 in connecting the cover assembly 26 and support structure 16. It is recognised that the tab 47 and slot 49 connection is considered one of the plurality of fastener mechanisms used to connect or otherwise fasten the support structure 16 to the cover assembly 26. It is also recognizable that the slot 49 could be on the offset flange 46 and the tab 49 could be on the cover panel 30, as desired.

The rear element 19a is connected to the top element 19b at the distal end 24 and to the bottom element 19c at the proximal end 22 of the support structure 16, such that the rear element 19b is positioned approximately perpendicular in orientation to the bottom element 19c, suitable for relatively level mounting surfaces 14. The front element 19d is connected to the top element 19b at the distal end 24 and to the bottom element 19c at the proximal end 22 of the support structure 16, such that the front element 19d is positioned approximately perpendicular in orientation to the bottom element 19c, suitable for relatively level mounting surfaces 14.

The bottom element 19c also has holes 24 for use with fasteners 25 for coupling the support member 18 to the cover panel 32 of the cover assembly 26, thus providing for the connection between the support structure 16 and cover assembly 26 components of the system 10. It is recognized that the support elements 19a,b,c,d can be other than as shown, including element configuration such as but not limited to bar stock, tube stock, stamped sheet stock, or a combination thereof. It is also recognized that the support member 18 can have any number of support elements 19a,b,c,d other than the four elements shown in FIG. 5. For example, referring to FIG. 6 is shown a support member 18 having only the bottom element 19c and modified front element 19d and rear element 19a, thereby relying upon the solar panel 12 (once connected) to contribute to the structural stability of the support member 18. It is also recognized that the angles between the elements 19a,b,c,d can be other than shown and that the support member 18 can be made of a support element of a unitary stamped sheet metal design (not shown).

### Cover Assembly 26

Referring to FIGS. 3 and 7, for example, the cover assembly 26 can have any number of cover panels 30 as desired and can be designed for load bearing or non-load bearing operation. As shown by example, the cover assembly 26 has the bottom panel 32 that has a plurality of holes (e.g. slots) 116 (or one extended hole portion) therein to accommodate for drainage of any water that has penetrated into the interior 28 as well as to accommodate the formation of low pressure zone in the vicinity of the mounting surface 14 adjacent to the venting 116. The rear cover panel 34 can be of a V-shaped configuration for wind deflection considerations and is positioned at a non-perpendicular angle with respect to the bottom cover panel 32, however is it recognised that the second cover 34 panel can also be of arcuate design (e.g. U-shaped). The optional front cover panel 36 can be of a shorter length than the length of the rear cover panel 34 to account for the inclined angle 20 of the solar panel 12 with respect to the mounting surface 14 (see FIG. 1). The front cover panel 36 can be straight and positioned at a non-perpendicular angle with respect to the bottom cover panel 32 for wind deflection considerations.

It is also recognised that in order to minimize point loads on the mounting surface 14, delivered via the mounting system 10, is the presence of the bottom cover panel 32 in the cover assembly 26 that provides for distribution of the loads (of the support structure 16, solar panel 12, snow loading and/or wind loading) of the mounting system 10 preferably uniformly across a maximized surface area. It is also recognised that the footings 48 can be used to assist in distribution of the loading onto the mounting surface 14. It is also recognised that the larger surface area of the bottom cover panel 32 provides for a greater surface area of the footings 48 to be used, which is advantageous as it can provide for greater friction forces (e.g. through a larger coefficient of friction and/or surface area) between the mounting system 10 and the mounting surface 14. It is recognised that greater friction forces are beneficial to the mounting system 10 since they help in resisting undesirable displacement of the mounting system 10 across the mounting surface 14 due to exerted wind forces.

In terms of the connections between the cover panels 30, shown by example is the cover assembly 26 manufactured out of a single piece of sheet material with fold lines 50 to delineate between the different cover panels 30 and fold line 51 used to form the individual angled surfaces 52 of the V-shaped rear cover panel 34. However, it is also recognized that the cover panels 30 could be individual sheets that are joined together using metallurgical (e.g. welding), chemical (e.g. adhesive), and/or mechanical fastening (e.g. screws, rivets, bolts, etc.) means, as desired.

Also, footings 48 (for example made of resilient material such as but not limited to rubber, plastic, foam or other resilient polymer material that can be considered a high compression strength material such as XPS foam insulation of density 25 lbs/in2) can be positioned between the cover assembly 26 and the mounting surface 14 to help minimize point loading on the mounting surface 14 as well as to provide for adequate water drainage.

FIG. 12 shows a partial footing 48 configuration providing for a space positioned between the footings 48 to provide for water drainage flow from the front to the rear of the system 10 once installed. Referring to FIG. 13, shown is an alternative embodiment of the footings 48 as a full footing that includes channels or slots 49 (also referred to as dimples) to facilitate water flow underneath the system 10 once installed on the mounting surface 14. It is also recognized that use of a full footing can provide for increased distribution of weight (e.g. a reduction in point loading) over the partial footing 48 assembly of FIG. 7. It is recognized that the footings 48 as a footing assembly could be adhered or otherwise fastened to the bottom surface of the bottom cover panel 32 in order to facilitate the spreading of ballast loads (not shown) over a greater surface area of the mounting surface 14. It is recognized that provision of the footings 48 may be preferred with the system 10, as the bottom cover panel 32 is preferably made of thinner gauge sheet material (as discussed above with reference to the cover panels 30 as a whole) and therefore the ability for the bottom cover panel 32 to spread ballast loads could be diminished in absence of the footings 48.

As discussed above, an advantage of having separate components of the support structure 16 and the cover assembly 26, in the case where the cover assembly 26 is non-load bearing, is that lower usage of material savings can be realized for the cover assembly 26, as the cover assembly 26 does not need to support the solar panel 12 in its installed position, as the retaining of the solar panel 12 in its installed position is the role or function of the support structure 16. In other words, the gauge of material for the cover assembly 26 can be minimized in order to save on cost of material for the overall mounting system 10. The preferred material in the solar racking marketplace is aluminum, which is a very expensive material so using anon-supporting cover assembly 26 provides for the use of thinner gauge aluminum in the claimed mounting system 10 over other racking systems known in the art that use their covers as cover structures to help support their solar panels. Prior art such as U.S. Pat. No. 6,968,654 or DE 20120983 uses their cover structure as their support for the solar panel, so they can't realistically use thinner gauge materials for cover manufacture. Therefore, the current mounting system 10 (for example venting 116 with gaps(s) 66) can offer a significant cost advantage and/or aerodynamic design advantages since it is recognised that the cover can use most of the material for the mounting system 10 and can contribute most of the cost to the product. An alternative material, stainless steel, has the same cost issue. Is it recognised that the footings 48 as a footing assembly can be attached to the bottom panel 32 of the cover assembly 26 (e.g. for either load bearing or non-load bearing designs) and can also be adapted for use with any other bottom panel design solar racking system where described in U.S. Pat. No. 6,968,654 or DE 20120983, in order to help provide for the aerodynamic design functionality afforded by the venting 116 in combination with the gap 66 associated with the rear cover panel 34 and/or in combination with the gap 66 associated with the front cover panel 36.

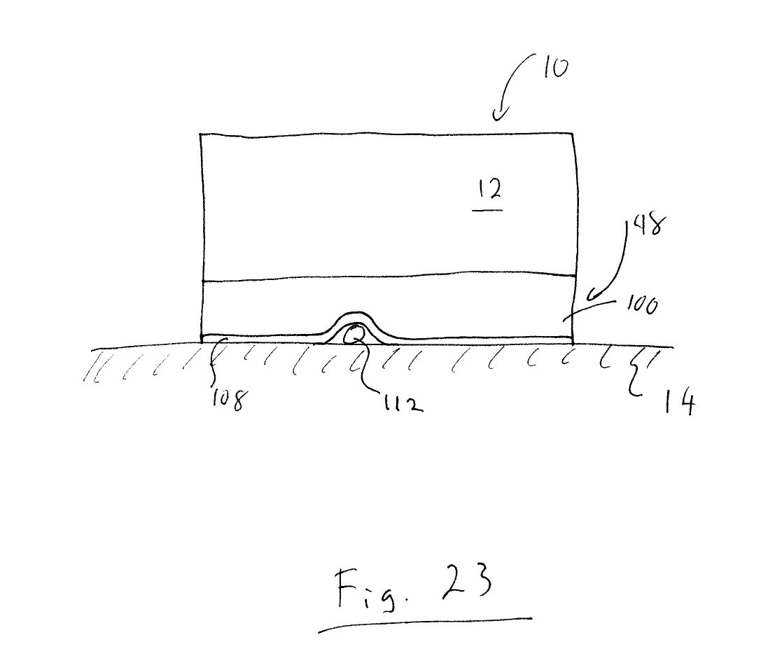

Referring to FIG. 19, shown is an alternative embodiment of the footings 48 having one or more grooves or slots 49 either formed or cut into a body 100 of the footings 48. The body 100 of the footings 48 is preferably formed from a closed-cell plastics based foam as compared to an open-cell foam, as further discussed below, and is preferably affixed (e.g. adhered using an adhesive, attached using one of more fasteners, etc.) to the bottom cover panel 32. The body 100 is composed of the closed-cell plastics based foam material capable of experiencing body deformation in the presence of rigid objects 112 (see FIG. 23) pressed against the body 100.

Referring to FIG. 20, shown are the slots 49 extending from one side 102 to an opposing side 104 of the body 100 along a first exterior face 106 that can be positioned adjacent to the mounting surface 14 (see FIG. 7) during installation of the racking system 10. The body 100 also has a third side 103 and a fourth side 105, such that the slot 49 is located in the exterior face 106 and extending from the first side 102 to the second side 104 opposite the first side 102 and positioned away from the third side 103 and the fourth side 105, such that the first side 102 and the second side 104 and the third side 103 and the fourth side 105 define the edges of the exterior face 106. It is recognized that the slot 49 allows for the flow of water between the first side 102 and the second side 104 when the exterior face 106 is positioned adjacent to the mounting surface 14. The body 100 also has a second exterior face 107 opposite the first exterior face 106 and configured for connecting to the bottom panel 32 of the ballasted mounting system 10.

Accordingly, once positioned adjacent to the mounting surface 14, water can drain through the footing 48 from the one side 102 to an opposing side 104 though the slot(s) 49. It is recognised there can be one or more (i.e. a plurality) of slots 49 positioned on the exterior face 106 of the body 100.

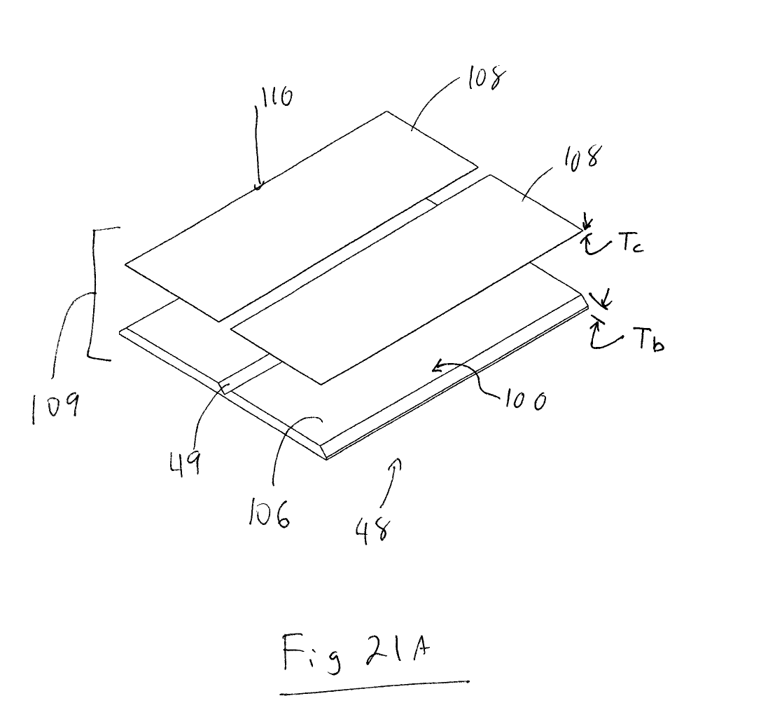

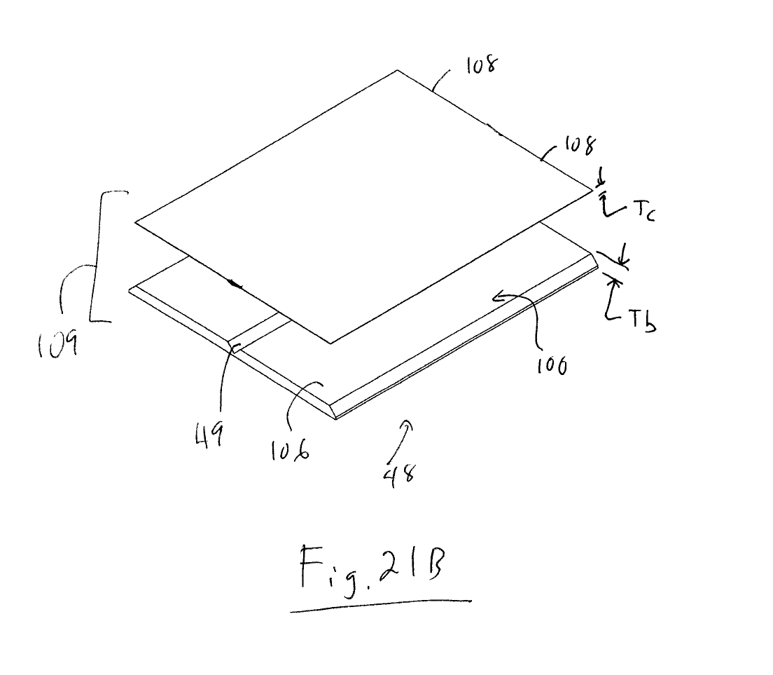

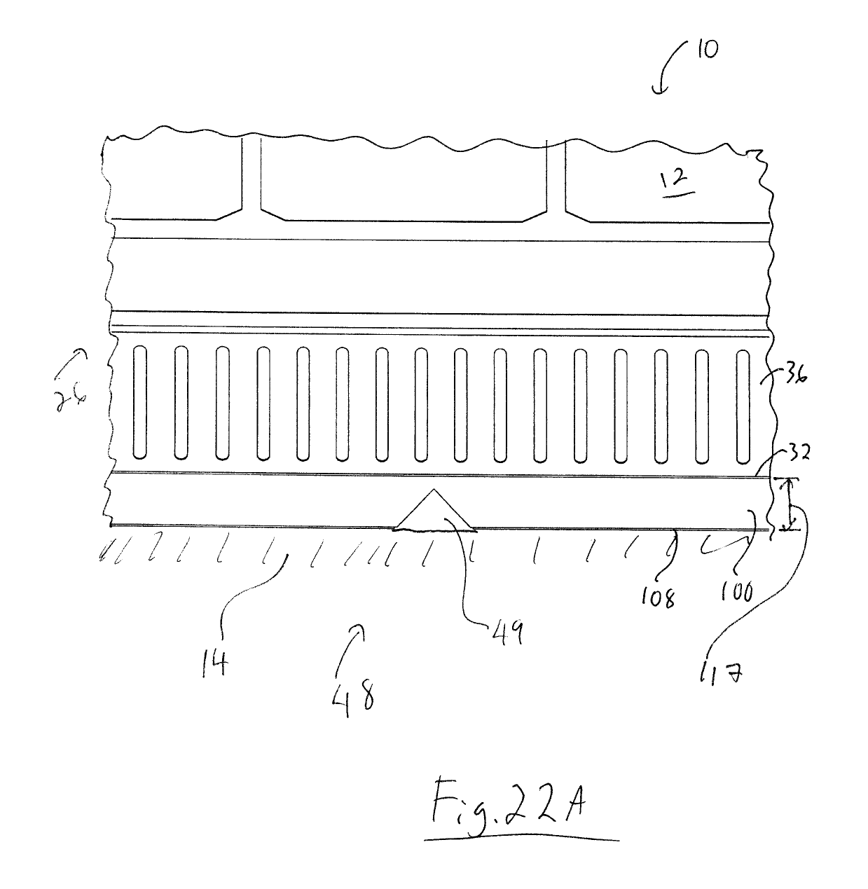

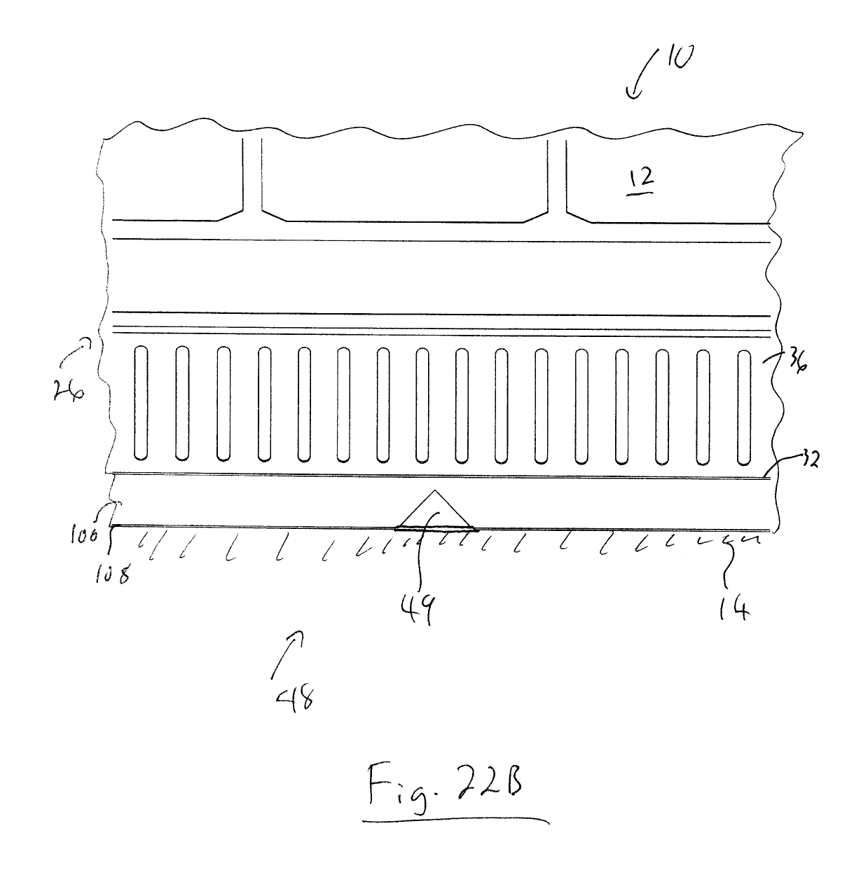

Referring to FIG. 21a, in order to increase the coefficient of friction of the footings 48 while at the same time retaining the desired impact absorbing characteristic of the body 100 formed of a closed-cell plastics based foam, the body 100 can have an optional cladding layer 108 having a coefficient of friction Cfc higher than that of the coefficient of friction Cfb of the body 100 material. It is also recognised that preferably the cladding layer 108 has a thickness Tc less than a thickness Tb of the body 100. The cladding layer 108 is preferably adhered (e.g. using a suitable adhesive) to the exterior face 106 of the body 100, as shown in FIG. 22, so that shifting or sliding between the cladding layer 108 and the exterior face 106 is inhibited. One example material of the cladding layer 108 is rubber or other polymer based material (e.g. flexible or rigid). As shown in FIG. 21a, the cladding layer 108 can be positioned on the exterior face 106 to either side of the slot 49, such that the stacked layer arrangement 109 of the cladding layer 108 and the body 100 provide an open faced slot 49 or series of open faced slots 49 on a peripheral surface 110 of the stacked payer arrangement 109. Alternatively, as shown in FIG. 21b, the cladding layer 108 can be positioned on the exterior face 106 across the slot 49, such that the stacked layers of the cladding layer 108 and the body 100 provide a closed faced slot 49 or passage in an interior of the stacked layer arrangement 109. It is also recognised that for a plurality of slots 49 in the body 100, the slots 49 can be configured as all open faced slots 49, all closed face slots 49, or a combination of open faced and closed faced slots 49, as desired. Refer to FIGS. 22a,b for assembled versions of the footing 48 mounted to the racking system 10 and positioned on the mounting surface 14.

It is recognised that the thickness Tc of the cladding layer 108 can be sized so as to allow for penetration of the flexible material of the cladding layer 108 into the body 100 in the presence of foreign objects 112 (see FIG. 23). Alternatively, the material of the cladding layer can be inflexible (i.e. may be rigid) but the thickness Tc of the cladding layer 108 can be appropriately sized so as to provide for tearing of the material of the cladding layer 108 to allow for penetration of the foreign object 112 into the body 100 material when present. Alternatively, the material of the cladding layer 108 can be flexible but can also be thin enough so as to provide for tearing of the material of the cladding layer 108 to allow for penetration of the foreign object 112 into the body 100 material when present. Accordingly, due to the preferable thinness off the cladding layer 108, the cladding layer 108 can also be referred to as a skin layer.

In terms of material properties of the body 100 material, closed-cell foams do not have interconnected pores. The closed-cell foams normally have higher compressive strength due to their structures over that of open celled foams. However, closed-cell foams are also in general denser and require more plastics material over that of open celled foams. The closed cells can be filled with a specialized gas to provide improved insulation. The closed-cell structure foams have higher dimensional stability, low moisture absorption coefficients, and higher strength compared to open-cell-structured foams. Accordingly, foam plastics can be synthesized in an “open cell” form, in which the foam bubbles are interconnected, as in an absorbent sponge, and “closed cell”, in which all the bubbles are distinct, like tiny balloons, as in gas-filled foam insulation.

It is recognised that the body 100 material can be manufactured out of various types of specially manufactured solid closed cell foams. A modern application of foam technology is Aerogel, which is a closed-cell foam with very good insulatory properties, that is also very light. Aerogel is usually based on alumina, chromia, and tin oxide, as well as carbon. The plastics material used to make the closed cell foams can be any plastic material consisting of a wide range of synthetic or semi-synthetic organic solids that are moldable. Plastics are typically organic polymers of high molecular mass, but they often contain other substances. They are usually synthetic, most commonly derived from petrochemicals, but many are partially natural. Thermoplastics as the base material for the body 100 material are the plastics that do not undergo chemical change in their composition when heated and can be molded repeatedly. Examples include polyethylene, polypropylene, polystyrene, polyvinyl chloride, and polytetrafluoroethylene (PTFE). Common thermoplastics range from 20,000 to 500,000 amu. These chains are made up of many repeating molecular units, known as repeat units, derived from monomers; each polymer chain will have several thousand repeating units.

As discussed above, now referring to FIG. 23, the body 100 material of the footings 48 is preferably a closed-cell plastics based foam in order to provide for local deformation 111 of the body 100 in the presence of rigid foreign objects 112 positioned between the mounting surface 14 and the footings 48 and/or due to surface irregularities 112 (e.g. rocks) of the mounting surface 14. In this manner, it is preferable that both the body 100 and adhered cladding layer 108 deform in the presence of the rigid foreign objects 112 rather than the footings 48 remain rigid (i.e. non-deformed) in the presence of load applied by the racking system 12. In the case of non-deformation, this could drive the foreign object/irregularity 112 into and possible penetrate the roof membrane of the mounting surface 14, thus potentially destroying the watertight integrity of the mounting surface 14. Therefore, the cladding layer 108 has to be of a material thickness Tc that allows for deformation (due to the presence of the rigid foreign object 112) of the cladding layer 108 into the body 100 material and/or allows for fracture (e.g. tearing) (due to the presence of the rigid foreign object 112) of the cladding layer 108 and resultant penetration of the rigid foreign object 112 into the body 100 material due to deformation of the body 100 material.

One example of the body 100 material can be expanded polystyrene (EPS) which is a rigid and tough, closed-cell foam. EPS is usually white and made of pre-expanded polystyrene beads. Familiar uses include moulded sheets for building insulation. Thermal resistivity of EPS is usually about 36 m·K/W but can range between 34 and 38 m·K/W depending on bearing/density. They conductivity of EPS varies between 0.034 and 0.038 W/(m·K) depending on bearing strength/density and the average value is approximately 0.036 W/(m·K). Adding graphite has recently allowed the thermal conductivity of EPS to reach around 0.030-0.034 and as such has a grey colour which distinguishes it from standard EPS. Water vapour diffusion resistance (μ) of EPS is around 30-70. Some EPS boards have a flame spread of less than 25 and a smoke-developed index of less than 450. The density range of EPS is about 16-640 kg/m3.

An alternative material for the body 100 is extruded polystyrene foam (XPS) consists of closed cells, which offers improved surface roughness and higher stiffness and reduced thermal conductivity over that of EPS. The density range of XPS is about 28-45 kg/m3. Because of the extrusion manufacturing process, XPS does not require facers to maintain its thermal or physical property performance. Thermal resistivity of XPS is usually about 35 m·K/W but can range between 29 and 39 m·K/W depending on bearing/density. Thermal conductivity of XPS varies between 0.029 and 0.039 W/(m·K) depending on bearing strength/density and the average value is about 0.035 W/(m·K). Water vapour diffusion resistance (μ) of XPS is around 80-250 and so makes it more suitable to wetter environments than EPS. Styrofoam is often also used as a generic name for all polystyrene foams.

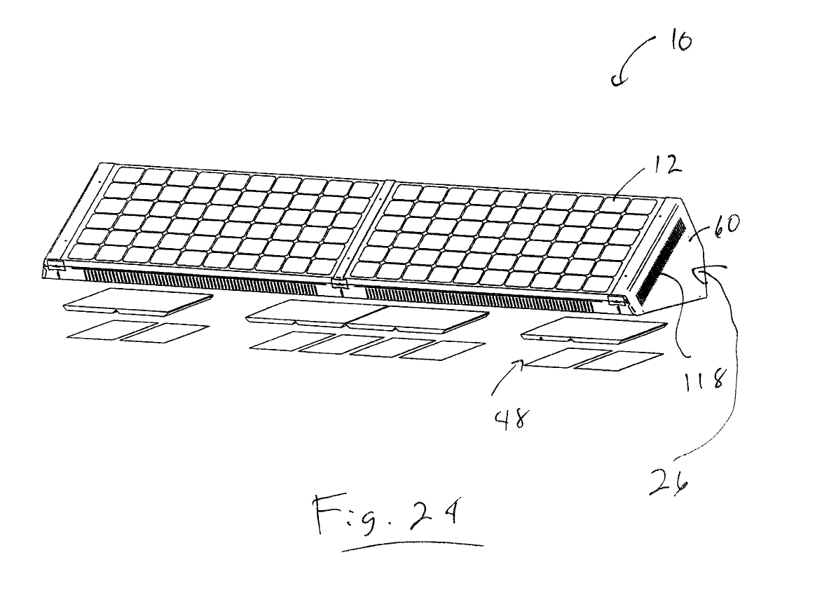

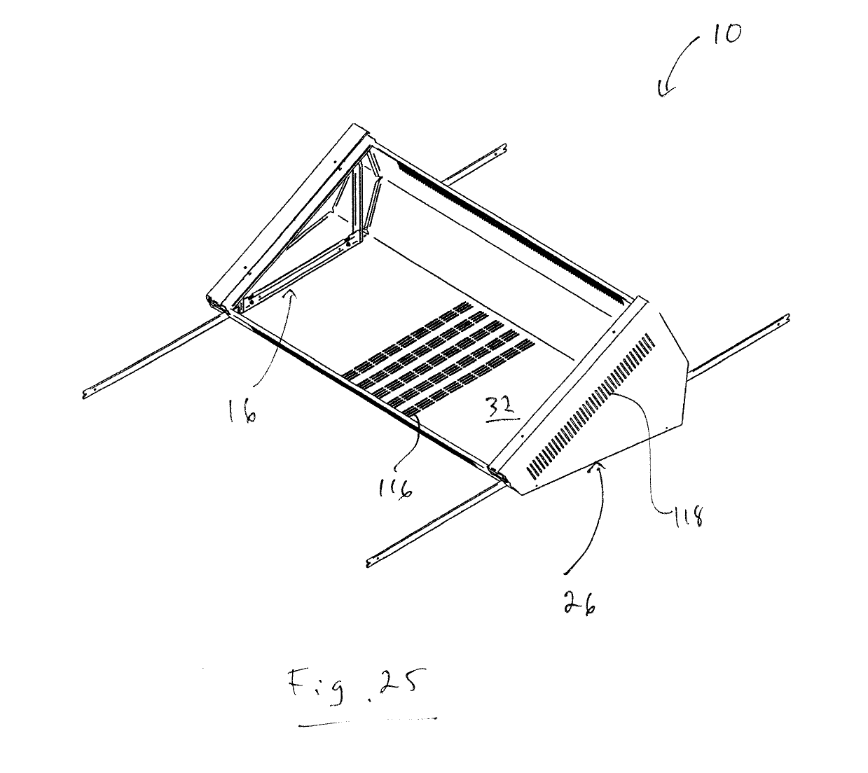

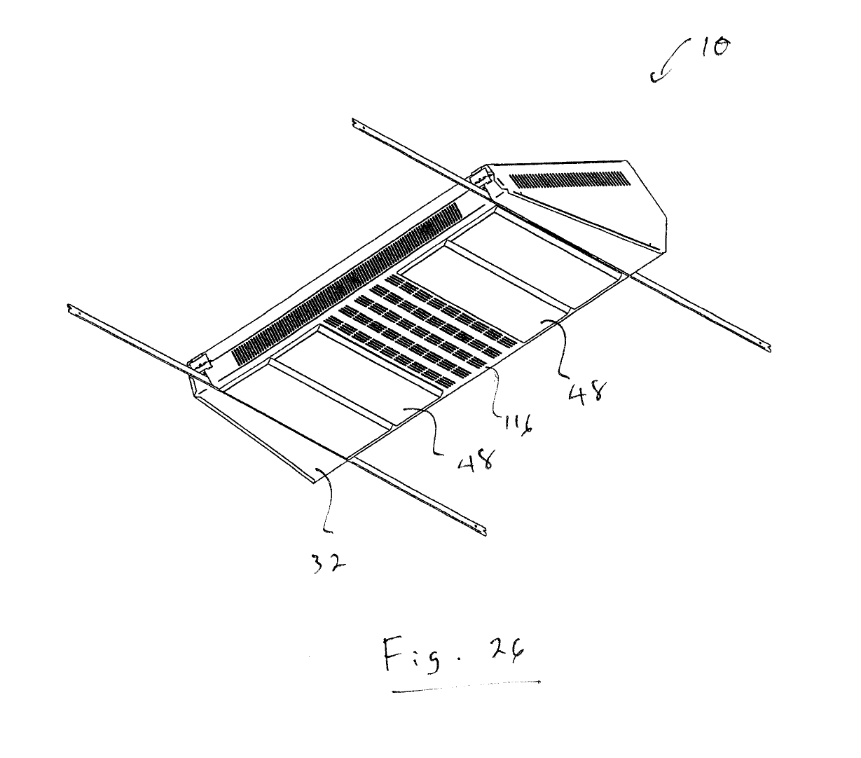

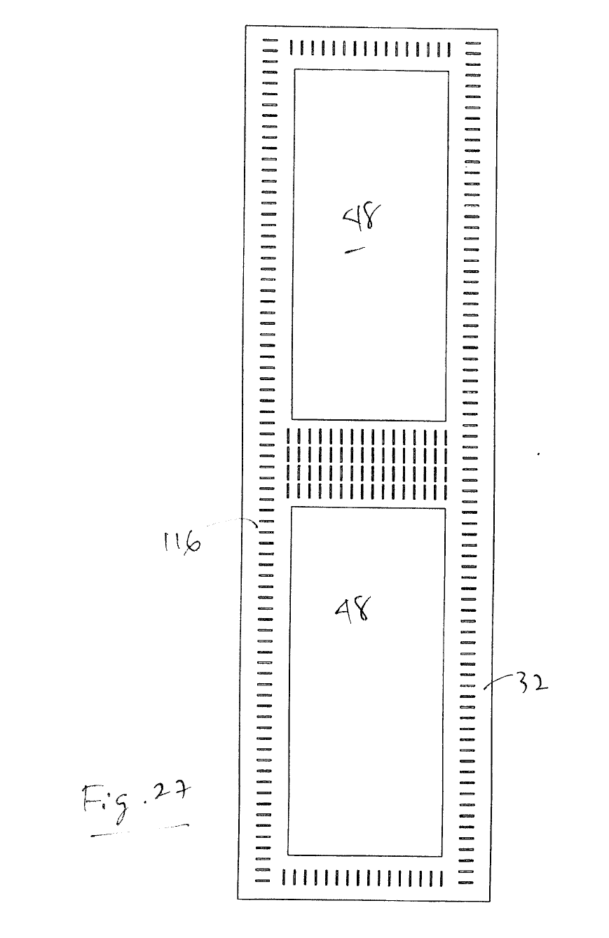

Referring to FIG. 24, shown is an expanded view of the racking system 10 with the footing 48 having the body 100 and the cladding layer 108.

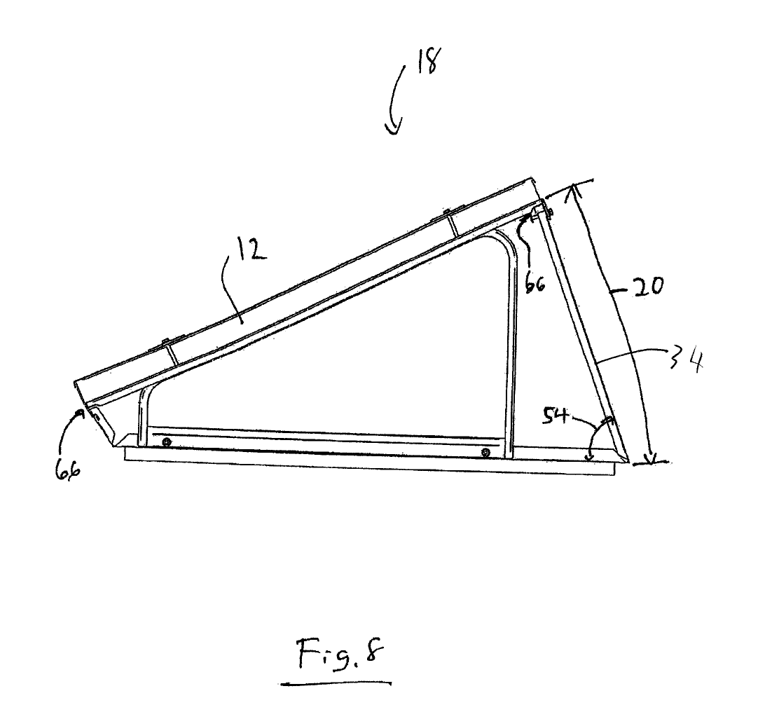

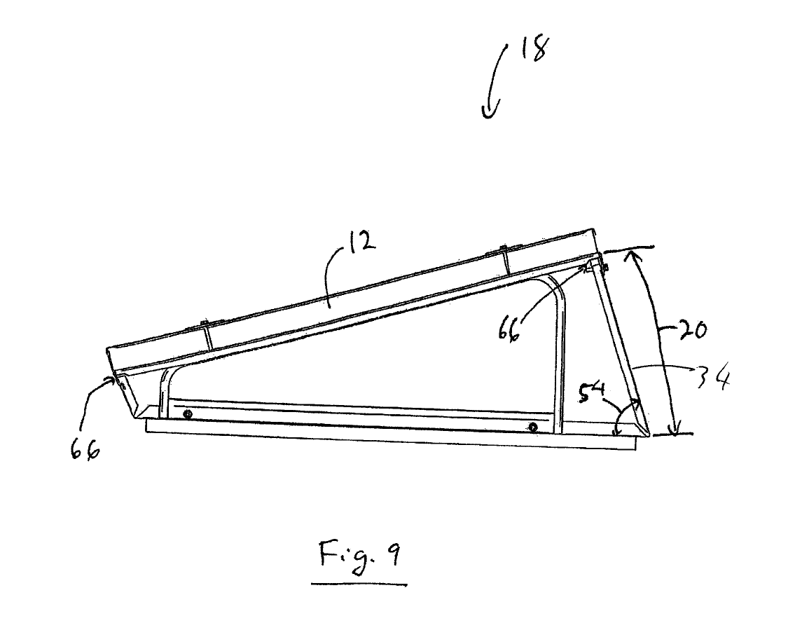

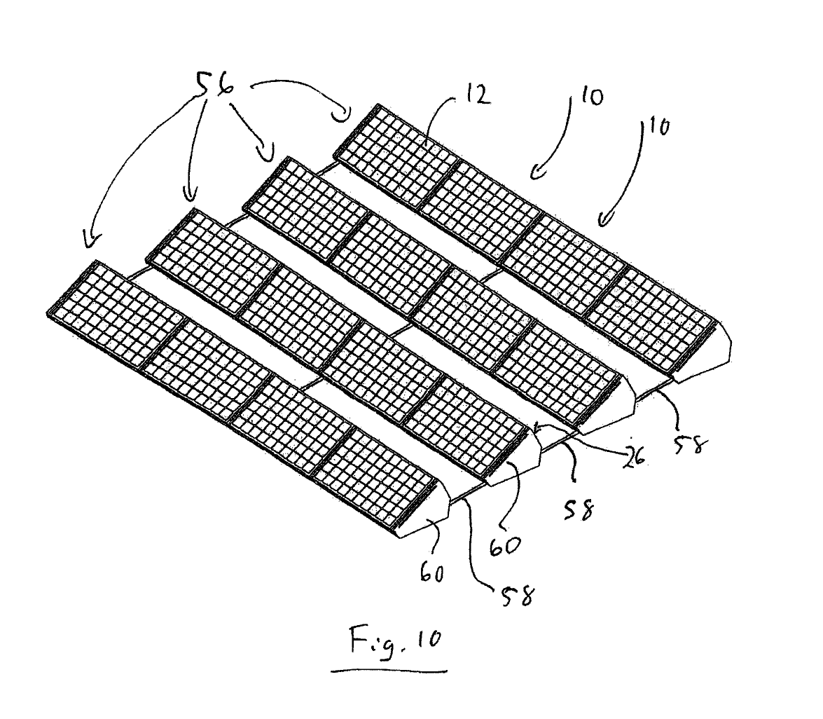

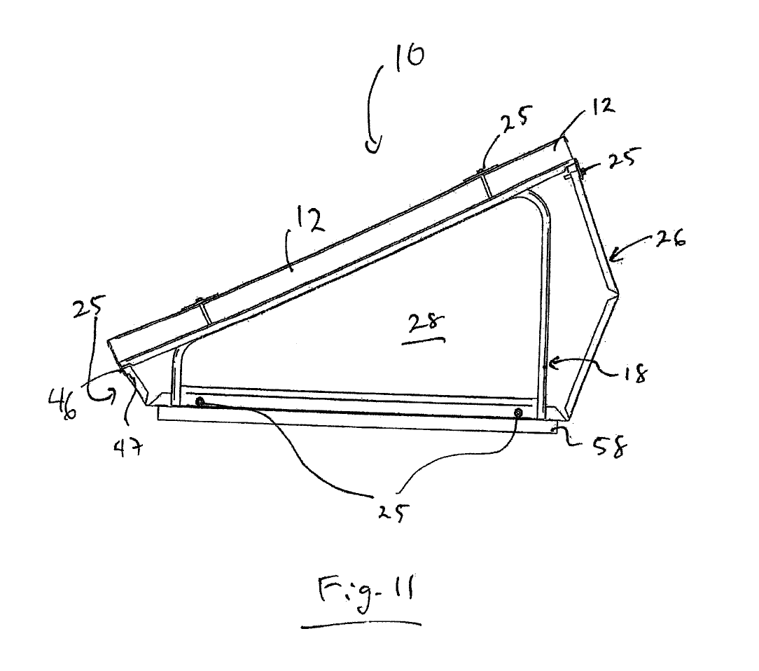

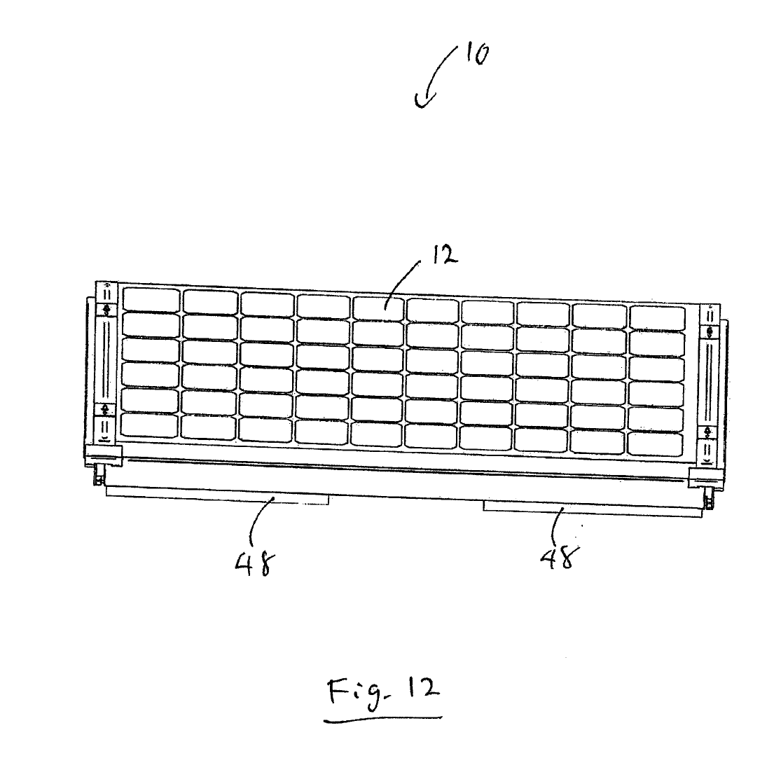

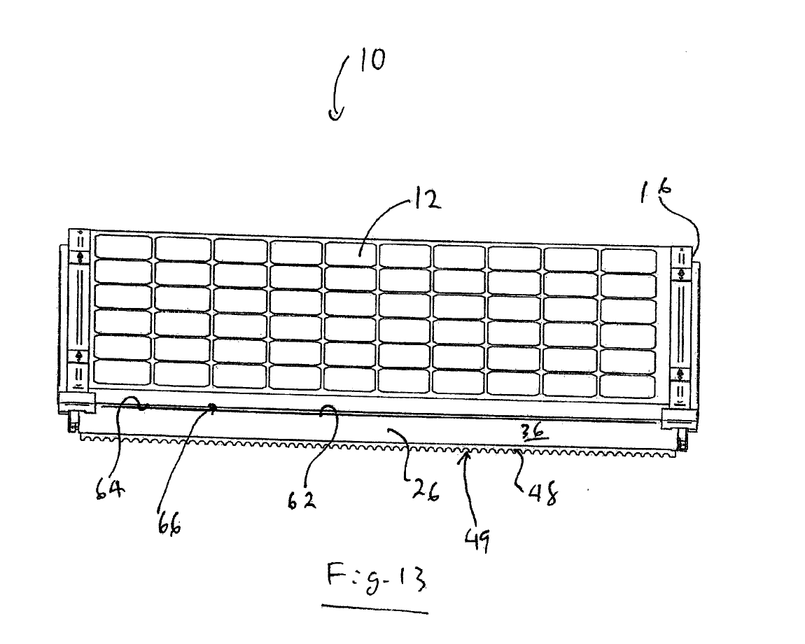

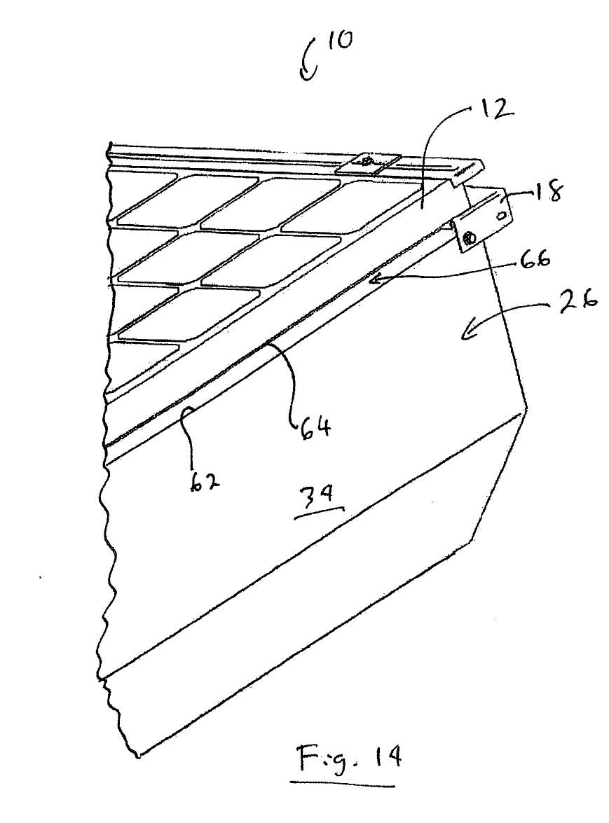

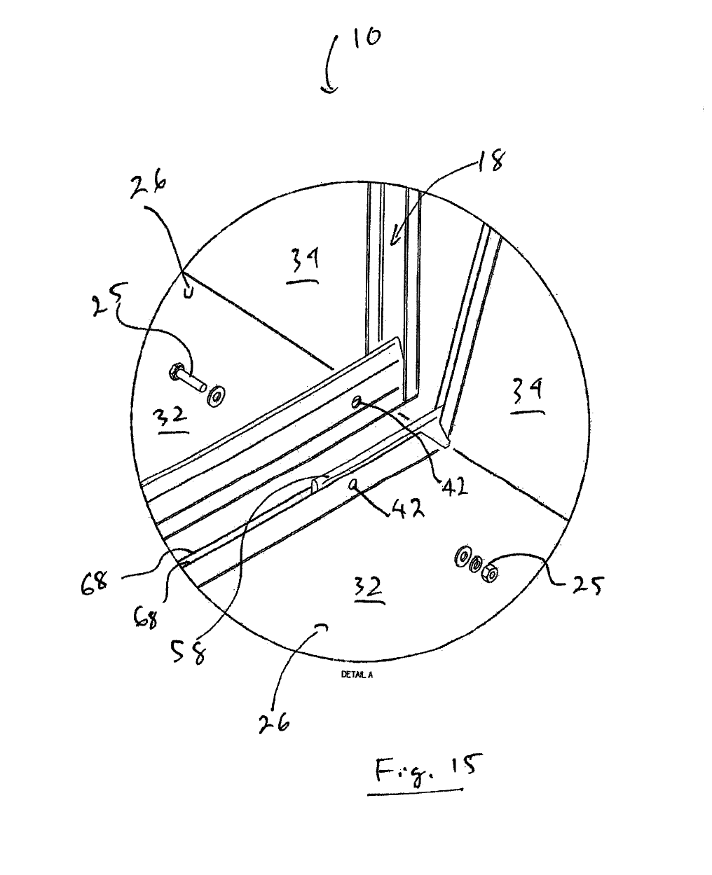

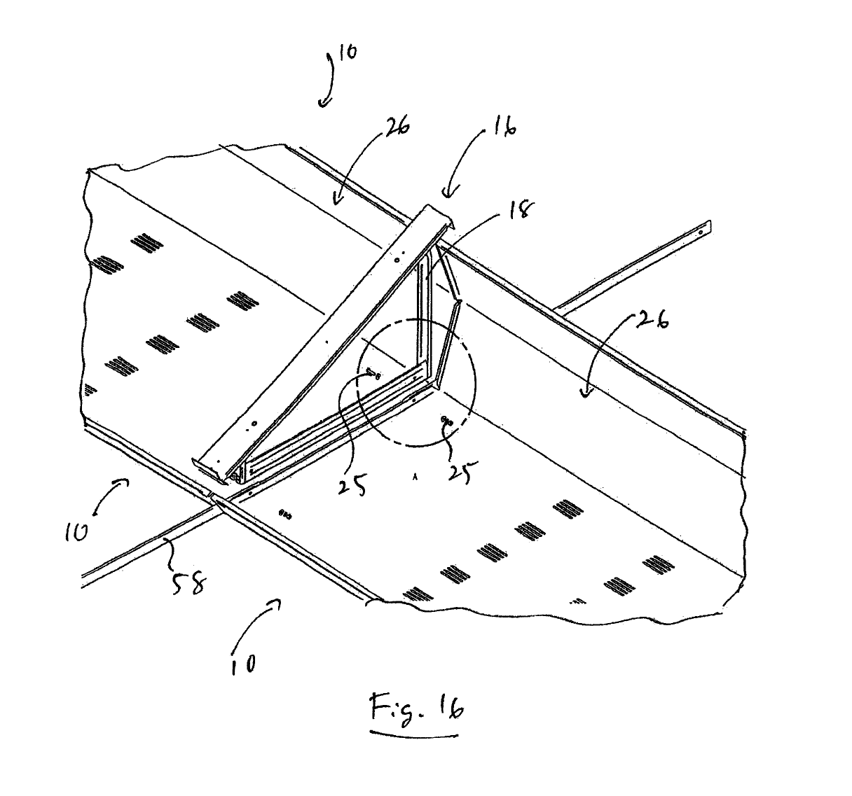

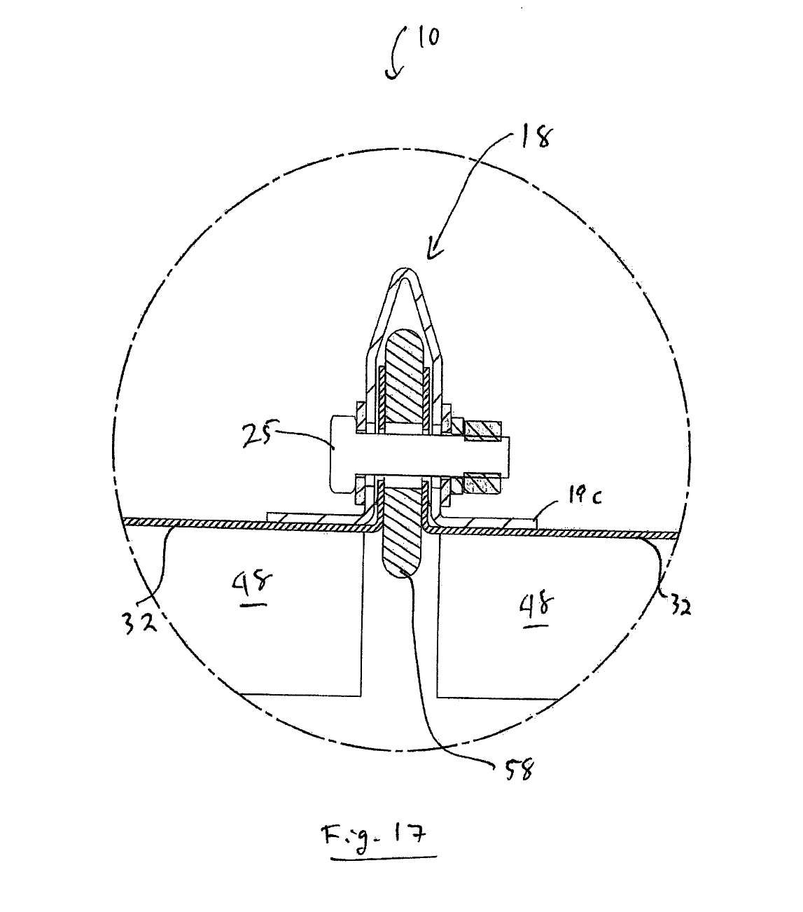

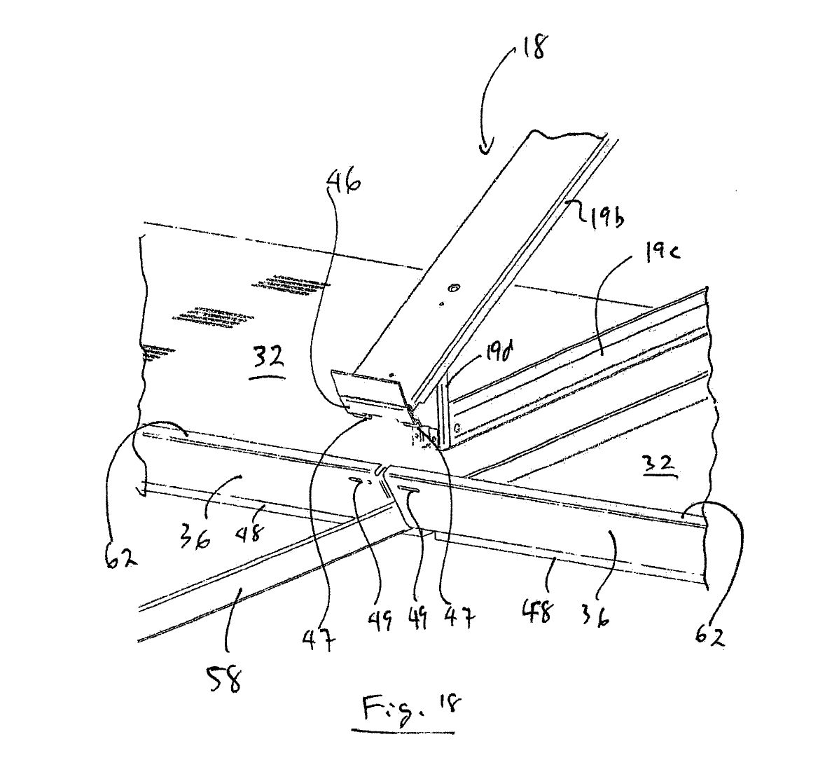

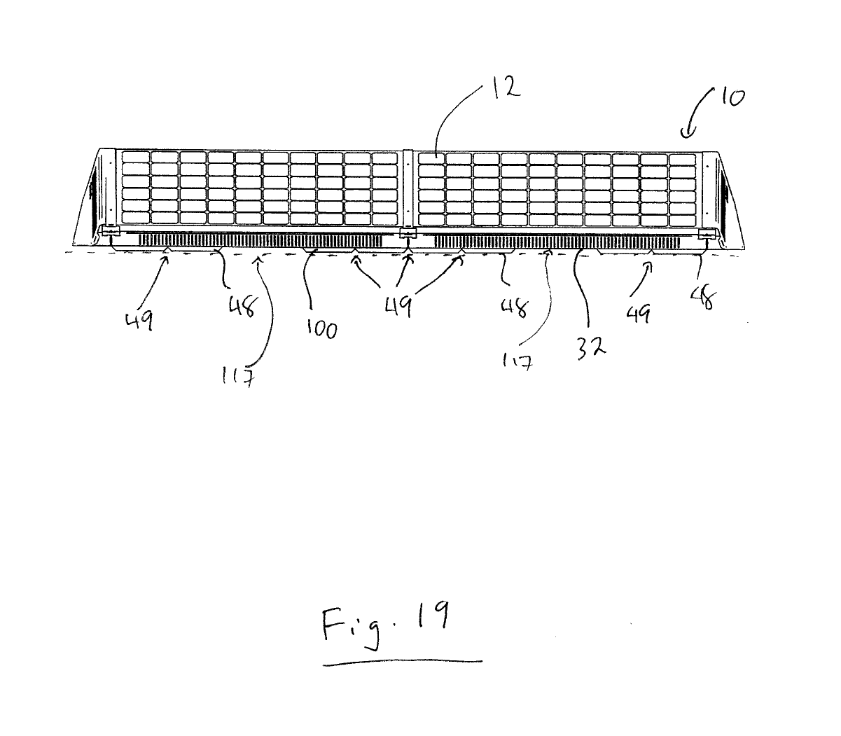

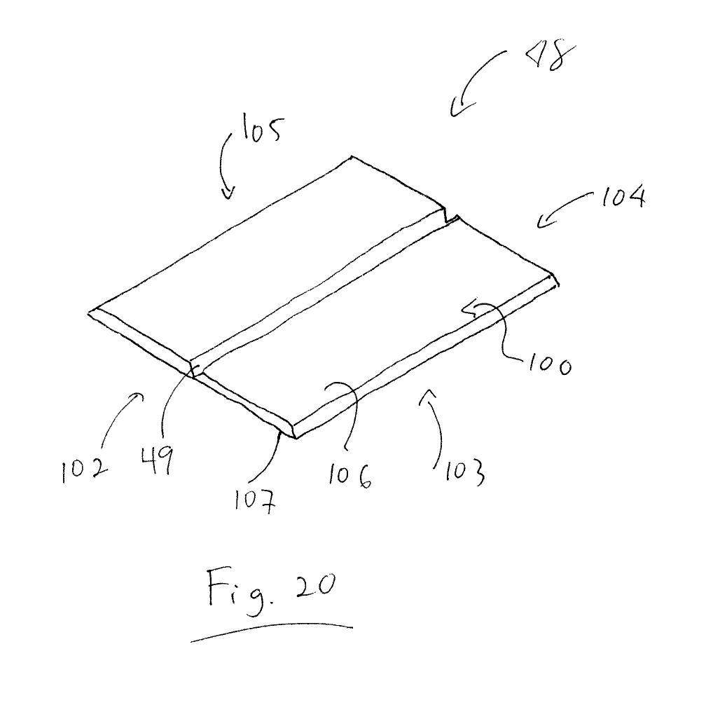

Referring to FIGS. 8 and 9, shown are alternative configurations of the cover assembly 26 for different inclination angles 20 and different non-perpendicular manufacture angles 54 to preferably account for variance in wind deflection considerations, as it is recognized that the rear cover panel 34 is preferably at the non-perpendicular angle 54 (e.g. an acute angle) with respect to the bottom cover panel 32 so that the rear cover panel 34 is configured as an angled back in order to help minimize the effect of wind loading on the system 10. Referring to FIG. 10, shown is an array of installed systems 10 in rows 56 interconnected by runners 58 used to interconnect the rows 56. Also shown is optional end cover panels 60 that are made of sheet material and considered as part of the cover assembly 26. It is recognized that the end cover panels 60 can be added to the ends of each row (e.g. two end cover panels 60 per row).

Referring to FIGS. 13 and 14, shown is the assembled system 10, such that a proximal edge 62 of the cover assembly 26 (see rear cover panel 34 and/or front cover panel 36 as an example) is spaced apart from a bottom surface 64 of the solar panel 12 (once installed on the support member 18), resulting in an air gap 66 between the cover panel 34, 36 and the solar panel 12. The air gap 66 is can be present with respect to the rear cover panel 34 and/or the front cover panel 36 in order to promote the low pressure zone in the interior 28. In terms of venting 116 (see FIG. 1, air gap(s) 66 can cooperate with venting 116 to promote the generation of the low pressure zone in the interior 28 of racking system 10.

In one embodiment, although, venting (e.g. air gap 66) or other venting configuration similar to venting 116 positioned near the top of the north side back deflector cover 34 can also beneficial for the same purpose of promoting the formation of the low pressure zone in the interior 28, whereby excessive ventilation on cover panel 34 may not be as desirable as it can create uplift forces if too much wind enters interior 28 and the wind becomes no longer deflected around rack system 10 in combination with formation of the low pressure zone in the interior 28. The bottom base (e.g. cover panel 32) can be a preferable location to maximize the venting 116 (for example in cooperation with air gaps 66), as the underside of racking system 10 is not exposed to the wind forces (relative to the side and top areas of rack system 10) but can still facilitate air to be entrained out of rack system interior 28, thus helping to create the desired low air pressure zone in the exterior 28 as compared to the air pressure about the exterior of racking system 10. For example, a preferred ventilation surface area (e.g. total surface area of all individual vent 116 openings in the cover 26) in the bottom base cover panel 32 is approximately equal to the cross-sectional surface area of the gap 117 (see FIGS. 22A and 19) between mounting surface 14 and the base cover panel 32, created by the raised footings 48 positioned between mounting surface 14 and the base cover panel 34. It is also recognised that optional venting 118 can be positioned on optional cover panels 60, as desired. Alternatively, optional cover panels 60 may be formed without venting 118.

It is also recognised that the total surface area of vents 116 positioned on the cover panel 32 can be designed as proportional (e.g. equal to, equal to or greater than, equal to or lesser than, greater than, less than, etc.) to the cross-sectional surface area of the gap 117 (see FIGS. 22A and 19) between mounting surface 14 and the base cover panel 32.

Other advantages to placement of venting 116 of cover assembly 26 preferably on bottom cover panel 32 is that too much ventilation on the back deflector panel 34 could also allow snow to enter the system 10 in the winter, which may not be the case as much with the bottom ventilation afforded by venting 116 on cover panel 32.

It is recognised that the air gap 66 between the panel 12 and cover assembly panel 34 (in combination with venting 116) helps to provide for a decrease in wind uplift forces experienced by the solar rack system 10, however it is also recognised that too large of an air gap 66 in this location can actually hinder or otherwise decrease this desired decrease in wind uplift forces. Accordingly, the venting 116 can also decrease any tendency for wind forces to create equal or higher pressures between the cover panel 32 and the mounting surface 14 and thereby cause the cover panel 32 to be lifted away from and off of mounting surface 14 or otherwise require an undesirable increase in ballast weight.

It is recognized that it is advantageous (for economic reasons related to manufacturing costs) to configure the length of the panels 34,36 to be shorter than the equivalent measured distance (e.g. either a straight-line distance in the case of the example front cover panel 36 of FIG. 7 or a V-shaped distance in the case of the example rear cover panel 34) between the bottom surface 64 of the solar panel 12 and the top surface of the bottom cover panel 32. Alternatively, in the absence of forward and/or rearward air gaps 66, convective cooling venting (not shown) would have to be machined into one or more cover panels 30 of the cover assembly 26, thus resulting in undesirably increased manufacturing costs of the cover assembly 26. In this manner, it is recognised that the panel(s) 30 of the cover assembly 26 is/are spaced away (e.g. via air gap(s) 66) from the bottom surface of the solar panel 12 and thus the cover panel assembly 26 is non-supporting of the solar panel 12. Instead, as discussed above the separate (i.e. attachable and detachable) components of the mounting system 10, being the cover assembly 26 and the support structure 16, perform their individual and separate functions of coverage of the mounting system 10 (e.g. for aerodynamic and/or debris collection considerations) and solar panel 12 support respectively.

### Solar Panel 12 Array Assembly

Referring to FIG. 10, as discussed above, the system 10 can be configured into a series of systems 10 in ordered rows 56, in order to accommodate an array of solar panels 12. One system in one of the rows 56 is connected to an adjacent system 10 in a neighboring row 56 by one or more of the runner elements 58 (e.g. metal bar stock, tube stock, etc.). Referring to FIG. 15, one example assembly configuration is where one of the support members 18 (via member element 19c) is fastened by fasteners 25 (e.g. nut and bolt combination in associate with holes 42) to adjacent bottom cover panels 32 (in the same row 56) of the respective adjacent cover assemblies 26. Interposed between the cover assemblies 26 is the runner element 58, which is connected to the adjacent cover assemblies 26 also using fasteners 25, in this case preferably the same fastener 25 used to connect the support member 18 together with the adjacent cover assemblies 26. Referring to FIG. 16, shown is a further view of the connection of system 10 to adjacent system 10 via connecting the support member 18 of the support structures 16 simultaneously with the fasteners 25 to each of the respective adjacent cover assemblies 26. It is also recognized that in the case of installing a series of rows 58 in a solar panel array, the runner element 58 can also be simultaneously connected via the same fastener 25 used to connect the system 10 to adjacent system 10 (in the same row 58). Referring to FIG. 17, shown is a cross sectional view of the example connection between adjacent systems 10.

It is also recognized that rather than sharing the support member 18 between the adjacent cover assemblies 26 as shown, a plurality of support members 18 could be positioned away from edge 68 of the cover assemblies 26 (i.e. away from the edge 68 towards the respective interiors 28 respective adjacent systems 10)—not shown—such that the runner element 58 is sandwiched directly between and connected to the adjacent cover assemblies 26. Also, FIG. 18 shows an embodiment of the fastening mechanism being a tab 47 and slot 49.

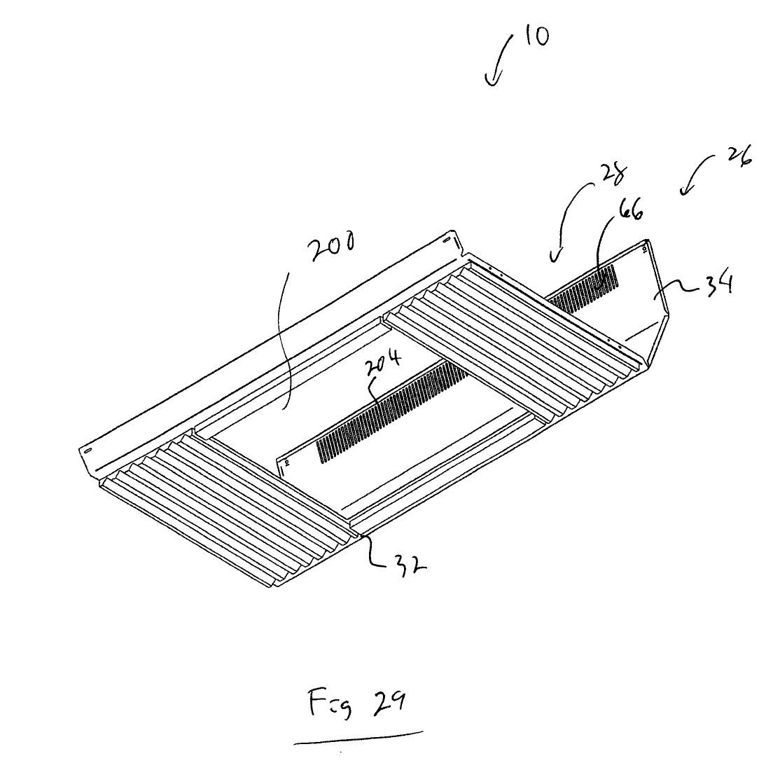

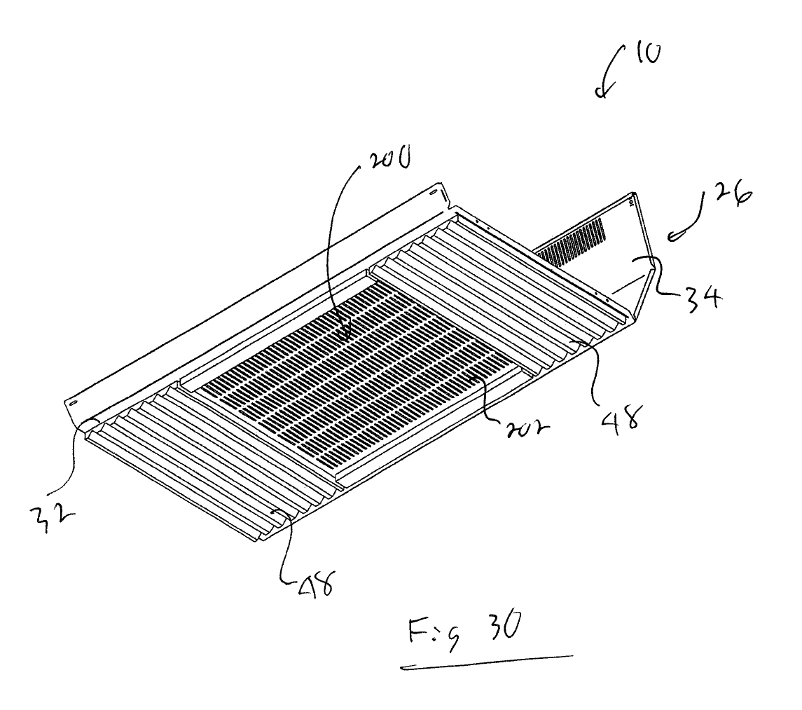

As shown in FIGS. 2 and 29, mounting system 10 for positioning a solar panel 12 on a mounting surface 14, the system comprising: a cover assembly 26 for coupling to the solar panel 12 for retaining the solar panel 12 over the mounting surface 14 at an inclined angle to the mounting surface 14, the cover assembly 26 having a proximal end for positioning adjacent to the mounting surface 14 and a distal end for coupling to the solar panel 13. The cover assembly 26 when coupled to the solar panel 12 cooperates to define the interior enclosed volume 28 between the cover assembly 26 and the solar panel 12. The cover assembly 26 has the first cover panel 32 of the cover assembly 26 comprising first sheet material positioned at the proximal end, the first cover panel 32 having a first aperture area 200 located on a portion of first cover panel 32, the first aperture area 200 having one or more first apertures 202 (see FIG. 30) extending through a thickness of the first sheet material providing for communication of air between the interior closed volume 28 and an ambient exterior of the cover assembly 26. The second cover panel 34 of the cover assembly 26 comprises second sheet material positioned between the proximal end and the distal end, the second cover panel 34 having a second aperture area 66 located on a portion of second cover panel 34, the second aperture area 66 having one or more second apertures 204 extending through a thickness of the second sheet material providing for communication of air between the interior closed volume 28 and the ambient exterior of the cover assembly 26.

As discussed above, the mounting system 10 can have optional support structure 16 (see FIG. 1) having a plurality of support members 18 configured for supporting weight of the solar panel 12, such that the support structure 16 is fastened to both the solar panel 12 and the cover assembly 26, the support structure 16 positioned in the interior enclosed volume 28. Alternatively, the cover assembly 26 is configured for supporting weight of the solar panel 12 such that the solar panel 12 is fastened to the cover assembly 26.

Referring again to FIGS. 3, 28, the first cover panel 32 is configured to position at the proximal end adjacent to the solar panel 12 at one end of the solar panel 12 and the second cover panel 34 is configured so as to position at the distal end adjacent to the solar panel 12 at the other end of the solar panel 12. For example, the second aperture area 66 can be located between the second cover panel 34 and the other end of the solar panel 12. Alternatively, the second aperture area 66 can be located on the second cover panel 34 and distant (not shown) from the other end of the solar panel 12.

Referring again to FIGS. 3, 28, a third cover panel 36 of the cover assembly 26 can comprise third sheet material positioned between the proximal end and the distal end while being opposite to the second cover panel 34. The third cover panel 36 can have a third aperture area 66 located on a portion of third cover panel 36, the third aperture area 66 having one or more third apertures extending through a thickness of the third sheet material providing for communication of air between the interior closed volume 28 and the ambient exterior of the cover assembly 26. The third cover panel can also be configured to position at the proximal end adjacent to the solar panel 12 at one end of the solar panel 12 and the second cover panel 34 configured so as to position at the distal end adjacent to the solar panel 12 at the other end of the solar panel 12. For example, the second aperture area 66 can be located between the second cover panel 34 and the other end of the solar panel 12 or the second aperture area 66 is located on the second cover panel 34 and distant from the other end of the solar panel 12.

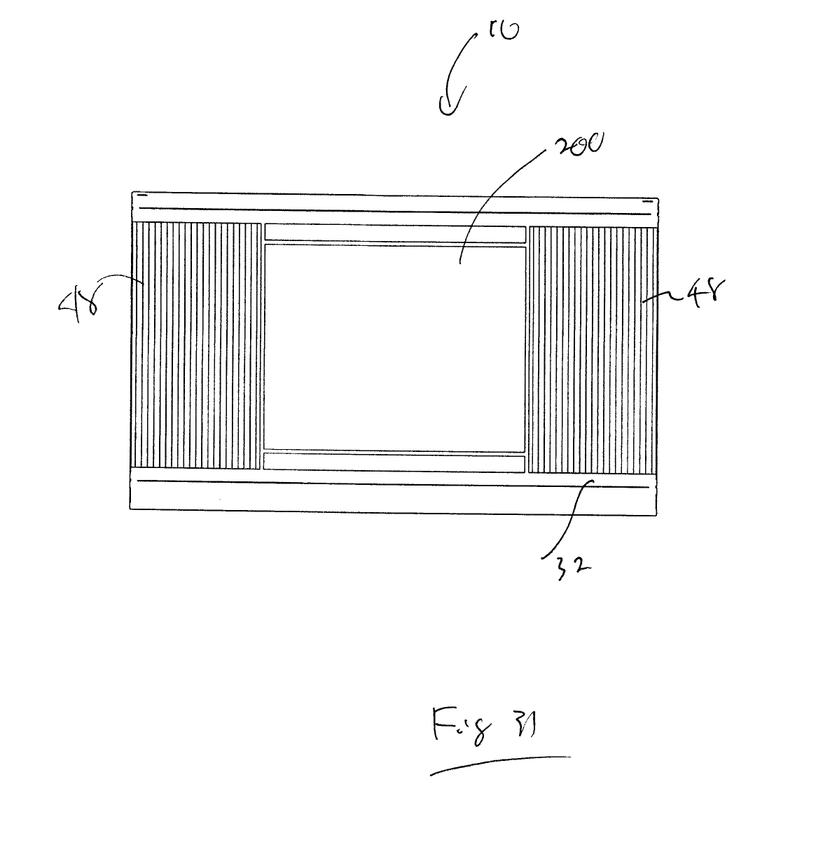

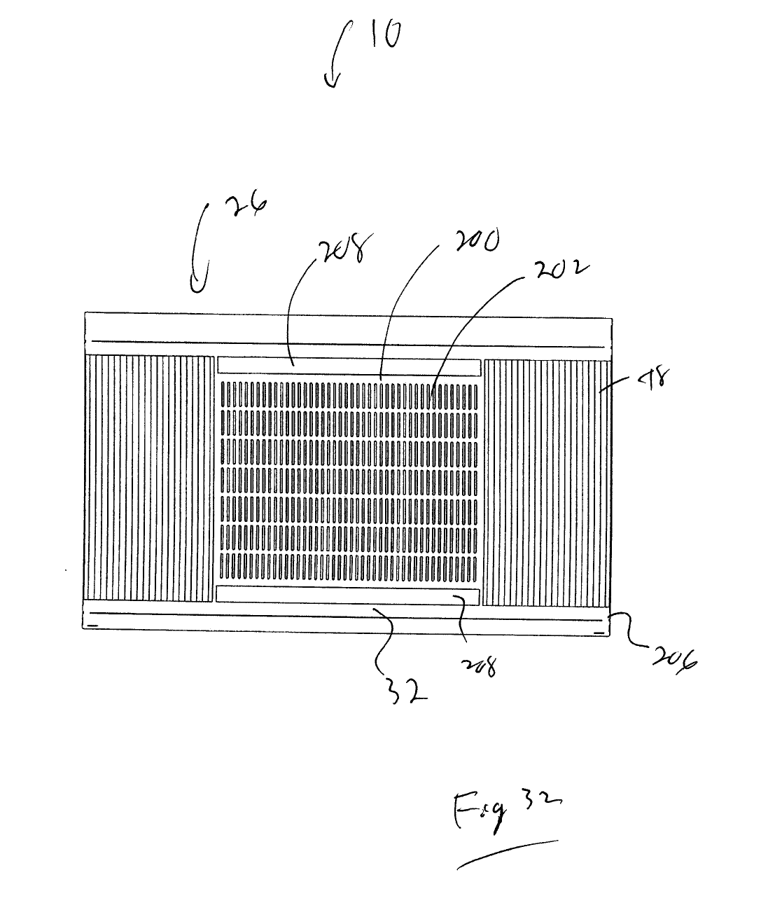

In terms of configuration of the first aperture area 200, FIG. 31 shows the first aperture area 200 consists of a single hole in the first sheet material. FIG. 32 shows the portion of the first cover panel 32 as the first aperture area 200 consisting of a plurality of holes 202 in the first sheet material. In FIG. 32, the portion of the first cover panel 32 is spaced distant from edges 206 of the first cover panel 32 in an interior of the first cover panel 32. This provides for sealing of the first aperture area 200 about its periphery (e.g. via foot portions 208 in co-operation with footing portions 48) with the mounting surface 14 so as to restrict the flow of air from the ambient exterior, through the first aperture area 200 and into the interior 28.

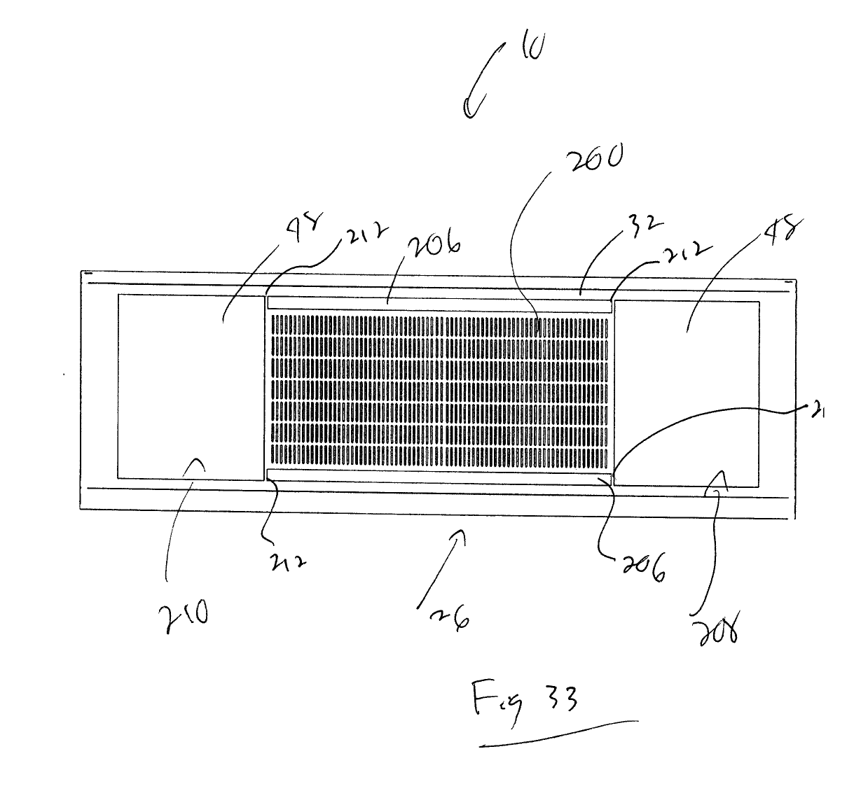

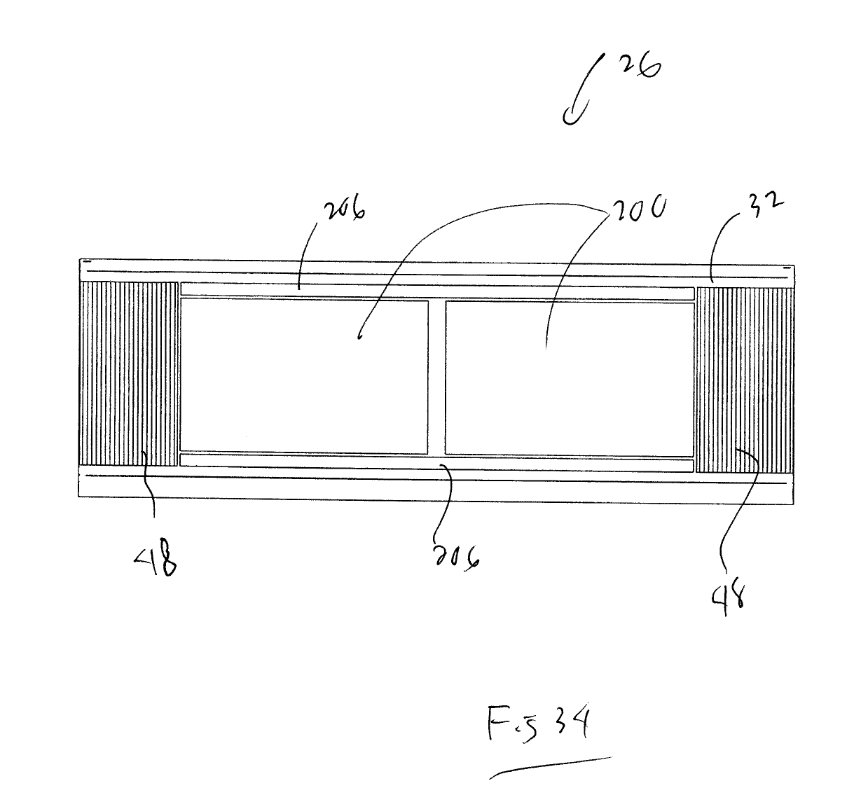

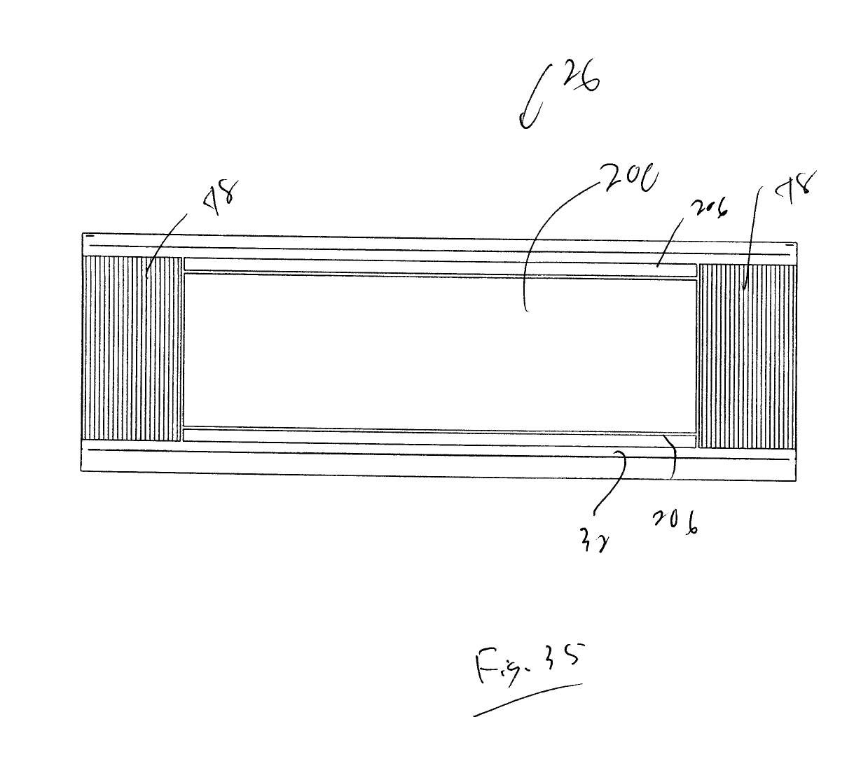

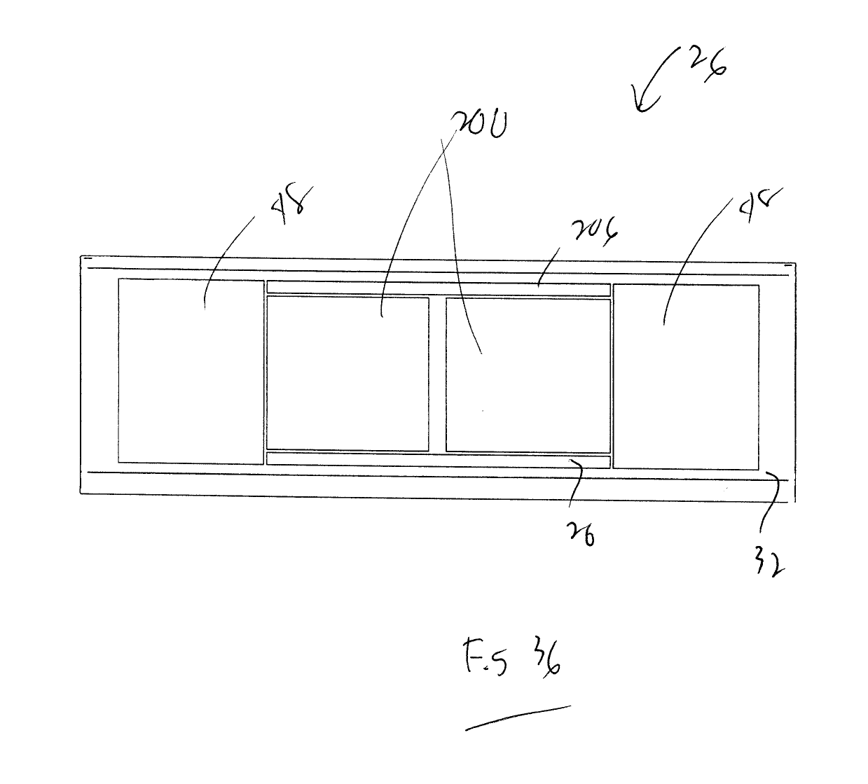

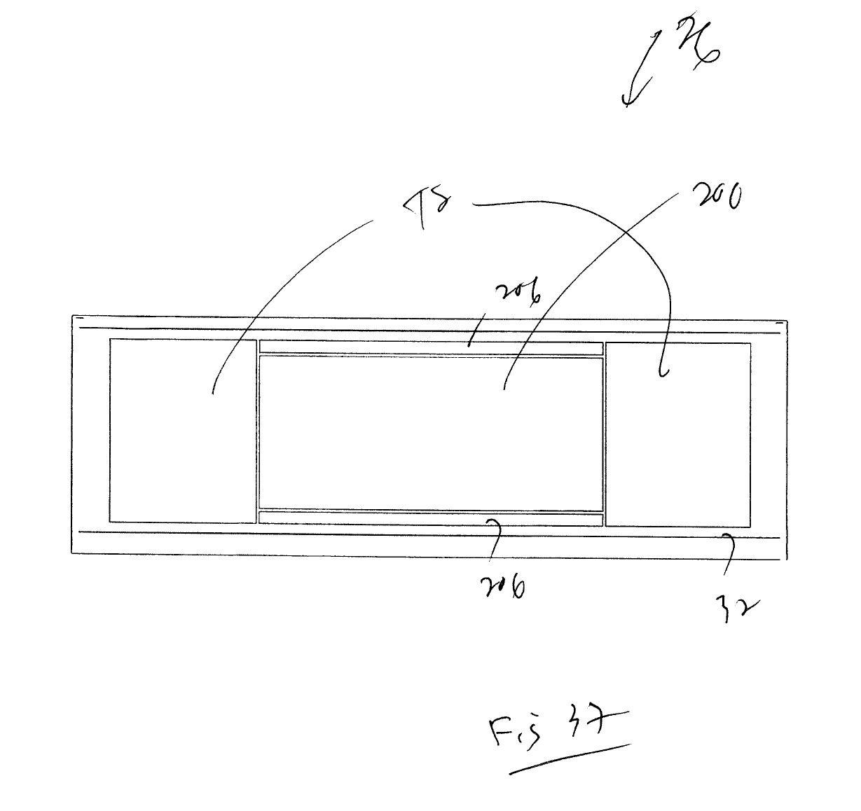

As such, FIGS. 2 and 33 shows an embodiment of a footing 48 positioned between the first cover panel 32 and the mounting surface 14, the footing 48 composed of resilient material suitable for distribution of weight of the mounting system 10 and the solar panel 12 supported thereon over surface area of the footing 48 in contact with the mounting surface 14. Further, the footing 48 has a first footing portion 208 positioned on the first cover panel 32 on one side of the first aperture area 200 and a second footing portion 210 positioned on the first cover panel 32 on the other side of the first aperture area 200. Optionally, the mounting system 10 further comprises an intermediate footing portion 206 of the footing assembly (e.g. 208, 210, 206), the intermediate footing portion 206 positioned on the first cover panel 32 between the first footing portion 208 and the second footing portion 210 so as to surround the first aperture area 200 as a footing assembly. Optionally the footing assembly can have slots 212 between the portions 206,208,210 or the intermediate footing portion 206 can be continuous with the first footing portion 208 and the second footing portion 210 to continuously surround the first aperture area 200 as a continuous footing assembly, such that the first aperture area 200 is isolated from the ambient exterior when the mounting system 10 is mounted on the mounting surface 14 so as to inhibit flow of air from the ambient exterior through the first aperture area 200 and into the enclosed interior volume 28.

As noted above, the mounting system 10 can have a plurality of the first aperture areas 200 and respective footing assembly (206,208,210) located in respective portions along the first cover panel 32.

We claim:

1. A mounting system for positioning a solar panel on a mounting surface, the system comprising:
a cover assembly for coupling to the solar panel for retaining the solar panel over the mounting surface at an inclined angle to the mounting surface, the cover assembly having a proximal end for positioning adjacent to the mounting surface and a distal end for coupling to the solar panel, the cover assembly when coupled to the solar panel cooperating to define an interior enclosed volume between the cover assembly and the solar panel;
a first cover panel of the cover assembly comprising first sheet material positioned at the proximal end, the first cover panel having a first aperture area located on a portion of first cover panel, the first aperture area having one or more first apertures extending through a thickness of the first sheet material providing for communication of air between the interior closed volume and an ambient exterior of the cover assembly;
a second cover panel of the cover assembly comprising second sheet material positioned between the proximal end and the distal end, the second cover panel having a second aperture area located on a portion of second cover panel, the second aperture area having one or more second apertures extending through a thickness of the second sheet material providing for communication of air between the interior closed volume and the ambient exterior of the cover assembly.

2. The mounting system of claim 1 further comprising a support structure having a plurality of support members configured for supporting weight of the solar panel, such that the support structure is fastened to both the solar panel and the cover assembly, the support structure positioned in the interior enclosed volume.

3. The mounting system of claim 1, wherein the cover assembly is configured for supporting weight of the solar panel such that the solar panel is fastened to the cover assembly.

4. The mounting system of claim 1, wherein the first cover panel is configured to position at the proximal end adjacent to the solar panel at one end of the solar panel and the second cover panel is configured so as to position at the distal end adjacent to the solar panel at the other end of the solar panel.

5. The mounting system of claim 4, wherein the second aperture area is located between the second cover panel and the other end of the solar panel.

6. The mounting system of claim 4, wherein the second aperture area is located on the second cover panel and distant from the other end of the solar panel.

7. The mounting system of claim 1 further comprising a third cover panel of the cover assembly comprising third sheet material positioned between the proximal end and the distal end while being opposite to the second cover panel.

8. The mounting system of claim 7, wherein the third cover panel having a third aperture area located on a portion of third cover panel, the third aperture area having one or more third apertures extending through a thickness of the third sheet material providing for communication of air between the interior closed volume and the ambient exterior of the cover assembly.

9. The mounting system of claim 7, wherein the third cover panel is configured to position at the proximal end adjacent to the solar panel at one end of the solar panel and the second cover panel is configured so as to position at the distal end adjacent to the solar panel at the other end of the solar panel.

10. The mounting system of claim 9, wherein the second aperture area is located between the second cover panel and the other end of the solar panel.

11. The mounting system of claim 9, wherein the second aperture area is located on the second cover panel and distant from the other end of the solar panel.

12. The mounting system of claim 1, wherein the portion of the first cover panel as the first aperture area consists of a single hole in the first sheet material.

13. The mounting system of claim 1, wherein the portion of the first cover panel as the first aperture area consists of a plurality of holes in the first sheet material.

14. The mounting system of claim 1, wherein the portion of the first cover panel is spaced distant from edges of the first cover panel in an interior of the first cover panel.

15. The mounting system of claim 1 further comprising a footing positioned between the first cover panel and the mounting surface, the footing composed of resilient material suitable for distribution of weight of the mounting system and the solar panel supported thereon over surface area of the footing in contact with the mounting surface.

16. The mounting system of claim 15, wherein the footing has a first footing portion positioned on the first cover panel on one side of the first aperture area and has a second footing portion positioned on the first cover panel on the other side of the first aperture area.

17. The mounting system of claim 16 further comprising an intermediate footing portion of the footing, the intermediate footing portion positioned on the first cover panel between the first footing portion and the second footing portion so as to surround the first aperture area as a footing assembly.

18. The mounting system of claim 17, wherein the intermediate footing portion is continuous with the first footing portion and the second footing portion to continuously surround the first aperture area as a continuous footing assembly, such that the first aperture area is isolated from the ambient exterior when the mounting system is mounted on the mounting surface so as to inhibit flow of air from the ambient exterior through the first aperture area and into the enclosed interior volume.

19. The mounting system of claim 17 further comprising a plurality of said first aperture area and respective said footing assembly located in respective said portion along the first cover panel.

20. The mounting system of claim 19, wherein the cover assembly is configured to support a plurality of said solar panel.

21. A footing for distributing loads over a mounting surface from a ballasted mounting system supporting a solar panel, the footing comprising: a body composed of a closed-cell plastics based foam material capable of experiencing body deformation in the presence of rigid objects pressed against the body having: a first exterior face of the body with at least one slot located in the exterior face and extending from a first side to a second side opposite the first side and positioned away from a third side and a fourth side, such that the first side and the second side and the third side and the fourth side define edges of the first exterior face, the at least one slot for allowing the flow of water between the first side and the second side when the first exterior face is positioned adjacent to the mounting surface; and a second exterior face of the body, the second exterior face opposite the first exterior face and configured for connecting to a bottom panel of the ballasted mounting system.

22. The footing of claim 21 further comprising a cladding layer affixed to the first exterior face to provide a stacked layer arrangement for the body with the affixed cladding layer, such that a thickness of the cladding layer is less than a thickness of the body and a coefficient of friction for material of the cladding layer is greater than a coefficient of friction for the closed-cell plastics based foam material, the thickness of the cladding layer providing for said body deformation when the rigid foreign object is pressed against the cladding layer.

23. The footing of claim 22, wherein the cladding layer is positioned to either side of the least one slot to provide for an open face slot.

24. The footing of claim 22, wherein the cladding layer is across the least one slot to provide for a closed face slot positioned in an interior of the stacked layer arrangement.

25. The footing of claim 22, wherein the material of the cladding layer is a polymer based material.

26. The footing of claim 25, wherein the polymer based material is rubber.

27. The footing of claim 25, wherein the thickness of the cladding layer is sized so as to allow for penetration of the material of the cladding layer via deformation of the cladding layer into the body in the presence of the foreign object.

28. The footing of claim 25, wherein the thickness of the material of the cladding layer is sized so as to provide for tearing of the material of the cladding layer to allow for penetration of the foreign object into the body when present.

29. The footing of claim 21, wherein the second exterior face of the body is affixed to the bottom panel of the ballasted mounting system, such that the bottom panel is one of a number of panels of a cover assembly of the ballasted mounting system.

30. The footing of claim 21, wherein the cover assembly is a non-load bearing component of the ballasted mounting system.

31. A footing for distributing loads over a mounting surface from a ballasted mounting system supporting a solar panel, the footing comprising: a body composed of a closed-cell plastics based foam material capable of experiencing body deformation in the presence of rigid objects pressed against the body 32 and a cladding layer affixed to a first exterior face of the body to provide a stacked layer arrangement for the body with the affixed cladding layer, such that a thickness of the cladding layer is less than a thickness of the body and a coefficient of friction for material of the cladding layer is greater than a coefficient of friction for the closed-cell plastics based foam material, the thickness of the cladding layer providing for said body deformation when the rigid foreign object is pressed against the cladding layer.

32. The footing of claim 31, wherein the body further comprising: the first exterior face of the body with at least one slot located in the exterior face and extending from a first side to a second side opposite the first side and positioned away from a third side and a fourth side, such that the first side and the second side and the third side and the fourth side define edges of the first exterior face, the at least one slot for allowing the flow of water between the first side and the second side when the first exterior face is positioned adjacent to the mounting surface; and a second exterior face of the body, the second exterior face opposite the first exterior face and configured for connecting to a bottom panel of the ballasted mounting system.

33. The footing of claim 32, wherein the cladding layer is positioned to either side of the least one slot to provide for an open face slot.

34. The footing of claim 32, wherein the cladding layer is across the least one slot to provide for a closed face slot positioned in an interior of the stacked layer arrangement.

35. The footing of claim 31, wherein the material of the cladding layer is a polymer based material.

36. The footing of claim 35, wherein the polymer based material is rubber.

37. The footing of claim 35, wherein the thickness of the cladding layer is sized so as to allow for penetration of the material of the cladding layer via deformation of the cladding layer into the body in the presence of the foreign object.

38. The footing of claim 35, wherein the thickness of the material of the cladding layer is sized so as to provide for tearing of the material of the cladding layer to allow for penetration of the foreign object into the body when present.

39. The footing of claim 21, wherein the second exterior face of the body is affixed to the bottom panel of the ballasted mounting system, such that the bottom panel is one of a number of panels of a cover assembly of the ballasted mounting system.

40. The footing of claim 21, wherein the cover assembly is a non-load bearing component of the ballasted mounting system.

41. The footing of claim 21, wherein the closed-cell plastics based foam material is extruded polystyrene foam.
